(19) United States
(12) Patent Application Publication
(10) Pub. No.: US 2019/0227649 A1
(43) Pub. Date: Jul. 25, 2019

(54) Pressure Signal Processing

(71) Applicant: Cambridge Touch Technologies Ltd., Cambridge (GB)

(72) Inventors: Riccardo Micci, Cambridge (GB); Matteo Vit, Cambridge (GB); Babak Bastani, Royston (GB); Arokia Nathan, Cambridge (GB)

(21) Appl. No.: 16/253,858

(22) Filed: Jan. 22, 2019

(30) Foreign Application Priority Data
Jan. 23, 2018 (GB) 1801099.1

(51) Int. Cl. G06F 3/044; G06F 3/041; G06F 3/01; G01L 1/16

(52) U.S. Cl. CPC G06F 3/044; G06F 3/0414; G06F 2203/04105; G01L 1/16; G06F 3/016

(57) ABSTRACT

A method of processing signals from a touch panel for combined capacitive and force sensing includes receiving, from the touch panel, pressure signals from a plurality of piezoelectric sensors and capacitance signals from a plurality of capacitive touch sensors. The method also includes determining, based on the capacitance signals, a user interaction period during which a user interaction with the touch panel occurs. The method also includes generating processed pressure signals based on the received pressure signals. The method also includes measuring a force applied to each of the plurality of piezoelectric sensors by the user interaction during the user interaction period by conditionally integrating the corresponding processed pressure signals according to a state register corresponding to the user interaction. The state register takes one of two or more values. Each user interaction is initialised in a first state value. The user interaction transitions between state register values in dependence upon the current state register value, and one or more pressure signal properties.

### CROSS-REFERENCE TO RELATED APPLICATIONS

This application is based upon, and claims the benefit of priority from United Kingdom Patent Application No. GB1801099.1, filed on Jan. 23, 2018, the entire contents of which are hereby incorporated by reference.

### FIELD OF THE INVENTION

The present invention relates to a touch panel for combined capacitive and pressure sensing.

### BACKGROUND

Resistive and capacitive touch panels are used as input devices for computers and mobile devices. One type of capacitive touch panel, projected capacitance touch panels, is often used for mobile devices because an exterior layer may be made of glass, providing a hard surface which is resistant to scratching. An example of a projected capacitance touch panel is described in US 2010/0079384 A1.

Projected capacitance touch panels operate by detecting changes in electric fields caused by the proximity of a conductive object. The location at which a projected capacitance touch panel is touched is often determined using an array or grid of capacitive sensors. Although projected capacitance touch panels can usually differentiate between single-touch events and multi-touch events, they suffer the drawback of not being able to sense pressure. Thus, projected capacitance touch panels tend to be unable to distinguish between a relatively light tap and a relatively heavy press. A touch panel that can sense pressure can allow a user to interact with a device in new ways by providing additional information to simply position of a touch.

WO 2016/102975 A2 and WO 2017/109455 A1 describe touch panels which are able to combine projected capacitance touch sensing with piezoelectric pressure sensing in a single touch panel.

Piezoelectric sensors generate transient signals, and there have been attempts to develop methods for converting the transient piezoelectric signals into signals which are representative of static applied forces. For example, WO 2017/122466 A1, JP 2015/097068 A and EP 2 902 886 A1 describe methods for conditional integration of signals from piezoelectric sensors.

### SUMMARY

According to a first aspect of the invention there is provided a method including receiving, from a touch panel, pressure signals from a plurality of piezoelectric sensors and capacitance signals from a plurality of capacitive touch sensors. The method also includes determining, based on the capacitance signals, a user interaction period during which a user interaction with the touch panel occurs. The method also includes generating processed pressure signals based on the received pressure signals. The method also includes measuring a force applied to each of the plurality of piezoelectric sensors by the user interaction during the user interaction period by conditionally integrating the corresponding processed pressure signals according to a state register corresponding to the user interaction. The state register takes one of two or more values. Each user interaction is initialised in a first state value. The user interaction transitions between state register values in dependence upon the current state register value and one or more pressure signal properties.

Pressure signal properties may include one or more of a signal value, a signal gradient, a signal variance or standard deviation, a signal range, a signal minimum, a signal maximum, a time elapsed since the start of the user interaction period, a time elapsed since the state register value was changed, a time elapsed since detecting a peak in the pressure signal, and so forth. Pressure signal properties may include comparing a signal value, a signal gradient, a signal variance or standard deviation, a signal range, a signal minimum or a signal maximum against one or more corresponding predetermined thresholds or ranges.

The piezoelectric sensors may be coplanar with, or provided within the same layer as, the capacitance sensors. The piezoelectric sensors and the capacitance sensors may comprise one or more electrodes in common. The piezoelectric sensors and the capacitance sensors may be provided by a single or common structure. The piezoelectric sensors and the capacitance sensors may be separate. The piezoelectric sensors and the capacitance sensors may be provided in separate layers.

Generating the processed pressure signals may include, for each piezoelectric sensor, subtracting a DC offset value from the received pressure signal. Each DC offset value may be initialised after a warm-up period has elapsed following switching on the touch panel. Each initial DC offset value may be based on the received pressure signals in the absence of a user interaction. Each initial DC offset value may be based on the mean, median, mode or range of the received pressure signals in the absence of a user interaction

The method may also include, for each piezoelectric sensor, in response to determining that there is no user interaction, maintaining a regression buffer of received pressure signal values, determining a gradient and variance of the values stored in the regression buffer, and in response to the gradient and variance being less than predetermined threshold values, updating the DC offset value based on the values stored in the regression buffer.

Generating processed pressure signals may include filtering the received pressure signals.

The method may also include, for each piezoelectric sensor, in response to detecting the start of a user interaction, setting a residual DC offset value to zero. The method may also include, during the user interaction period, maintaining a sample buffer of processed pressure signal values, determining a gradient and variance of the values stored in the sample buffer, determining a difference between the residual DC offset value and the average value of the values stored in the sample buffer. The method may also include, in response to the gradient and variance being less than corresponding flat-period threshold values and the difference being less than an offset-shift threshold, updating the residual DC offset value to the average value of the values stored in the sample buffer. The method may also include subtracting the residual DC offset value from the processed pressure signal before integration.

The method may also include setting a movement flag to a value of true in response to determining, based on the capacitance signals, that the location of a user interaction is moving. The method may also include, in response to the movement flag does not have a value of true, setting the flat-period threshold values to first predetermined flat-period threshold values. The method may also include, in response to the movement flag has a value of true, setting the flat-period threshold values to second predetermined flat-period threshold values.

The method may also include, for each piezoelectric sensor, locating and determining an initial peak value of the processed pressure signal during the user interaction period.

The method may also include, in response to locating an initial peak value, setting a user interaction type register to correspond to a soft touch value in response to the elapsed time since the start of the user interaction period exceeds a predetermined threshold value. The method may also include, in response to locating an initial peak value, setting the user interaction type register to correspond to a hard touch value in response to the elapsed time since the start of the user interaction period does not exceed the predetermined threshold value.

The method may also include setting the user interaction type register to the hard touch value in response to the residual DC offset value is updated and the user interaction type register corresponds to the soft touch value.

The method may also include setting the user interaction type register to the soft touch value in response to the processed pressure signal exceeds a predetermined fraction of the initial peak value, the gradient of the values stored in the sample buffer exceed a soft-transition threshold, and the user interaction type register corresponds to the hard touch value.

The method may also include setting the flat-period threshold values to third predetermined flat-period threshold values in response to the user interaction type register corresponds to the soft touch value.

The method may also include setting the state register to a second state value in response to the state register corresponds to the first state value, a time elapsed since the start of the user interaction exceeds a minimum duration and the processed pressure signal has a sign corresponding to an increasing force.

The method may also include setting the state register to a third state value in response to the state register corresponds to the second state value and the processed pressure signal has a sign corresponding to a decreasing force.

The method may also include setting the state register to a third state value in response to the state register corresponds to the second state value and the user interaction type register corresponds to the soft touch value.

The method may also include determining a signal gradient of the processed pressure signal during the user interaction. The method may also include setting the state register to a fourth state value in response to the state register corresponds to the third state value and the processed pressure signal has a signal gradient below a signal gradient threshold.

The method may also include, if the state register corresponds to the first state value, processed pressure signal values having a sign corresponding to an increasing force are integrated and processed pressure signal values corresponding to a decreasing force are not integrated.

The method may also include, if the state register corresponds to the second state value, all processed pressure signal values are integrated.

The method may also include, if the state register corresponds to the third state value, no processed pressure signal values are integrated

The method may also include, if the state register corresponds to the fourth state value, processed pressure signal values which exceed a noise threshold are integrated and processed pressure signal values which do not exceed the noise threshold are not integrated.

The state register may be set separately for each of the plurality of piezoelectric sensors.

The method may also include determining, based on the capacitance signals, two or more user interactions with the touch panel.

The method may also include determining a location of each user interaction based on the capacitance signals. The method may also include assigning a piezoelectric sensor which is closest to the location of each user interaction as a decision making sensor. The method may also include assigning each other piezoelectric sensor to correspond to the closest decision making sensor. The method may also include, in response to a piezoelectric sensor is a decision making sensor, updating a state register corresponding to the piezoelectric sensor independently. The method may also include, in response to a piezoelectric sensor is not a decision making sensor, updating a state register corresponding to the piezoelectric sensor to be equal to the state register of the corresponding decision making sensor.

The method may also include, in response to a piezoelectric sensor is not a decision making sensor, determining the location of the initial peak value based on the corresponding decision making channel.

The method may also include processing signals from decision making sensors before processing signals from the other piezoelectric sensors.

The method may also include providing input to a graphical user interface and/or a computer program based on one or more of the measured forces.

The state register may store values in the form of integers, characters, strings or floating point values.

According to a second aspect of the invention, there is provided a computer program product storing instructions for executing the method.

According to a third aspect of the invention, there is provided a computer program stored on a non-transitory computer readable medium and comprising instructions for causing a data processing apparatus to execute the method.

According to a fourth aspect of the invention, there is provided a controller configured to carry out the method.

Apparatus may include the controller and a touch panel which includes a plurality of piezoelectric sensors and a plurality of capacitive touch sensors.

According to a fifth aspect of the invention, there is provided a controller configured for connection to a touch panel comprising a plurality of piezoelectric sensors and a plurality of capacitive touch sensors, the controller configured to receive pressure signals from the plurality of piezoelectric sensors and capacitance signals from the plurality of capacitive touch sensors. The controller is also configured to determine, based on the capacitance signals, a user interaction period during which a user interaction with the touch panel occurs. The controller is also configured to generate processed pressure signals based on the received pressure signals. The controller is also configured to measure a force applied to each of the plurality of piezoelectric sensors by the user interaction during the user interaction period by conditionally integrating the, corresponding processed pressure signals according to a state register corresponding to the user interaction. The state register takes one of two or more values. Each user interaction is initialised in a first state value. The user interaction transitions between state register values in dependence upon the current state register value and one or more pressure signal properties.

Pressure signal properties may include one or more of a signal value, a signal gradient, a signal variance or standard deviation, a signal range, a signal minimum, a signal maximum, a time elapsed since the start of the user interaction period, a time elapsed since the state register value was changed, a time elapsed since detecting a peak in the pressure signal, and so forth. Pressure signal properties may include comparing a signal value, a signal gradient, a signal variance or standard deviation, a signal range, a signal minimum or a signal maximum against one or more corresponding predetermined thresholds or ranges.

Apparatus may include the controller and a touch panel comprising a plurality of piezoelectric sensors and a plurality of capacitive touch sensors.

### BRIEF DESCRIPTION OF THE DRAWINGS

Certain embodiments of the present invention will now be described, by way of example, with reference to the accompanying drawings in which:

FIG. 1 is a schematic cross section of a touch panel for combined piezoelectric and capacitive sensing;

FIG. 2 illustrates a system for combined piezoelectric and capacitive sensing;

FIG. 3 schematically illustrates a force profile of a user interaction with a touch panel;

FIG. 4 illustrates an idealised piezoelectric pressure signal corresponding to the force profile shown in FIG. 3;

FIG. 5 shows an example of a measured piezoelectric pressure signal corresponding to a user interaction with a touch panel;

FIG. 6 shows an applied force measured based on the piezoelectric pressure signal shown in FIG. 5;

FIG. 7 is a process-flow diagram of a method of measuring the force applied to a touch panel;

FIG. 8 is a process-flow diagram of an exemplary implementation of a method of measuring the force applied to a touch panel;

FIG. 9 is a process-flow diagram of a calibration process;

FIG. 10 is a process-flow diagram of a first example of a re-calibration process;

FIG. 11 is a process-flow diagram of a second example of a re-calibration process;

FIG. 12 is a process-flow diagram of a push elaboration process;

FIG. 13 illustrates the positions of a number of concurrent user interactions with a touch panel;

FIG. 14 illustrates assigning decision making electrodes of a touch panel system;

FIG. 15 illustrates assigning the dependence of non-decision making electrodes of a touch panel system on decision making electrodes;

FIG. 16 illustrates processing of signals from an electrode of a touch panel system;

FIG. 17 shows an example of a measured piezoelectric pressure signal corresponding to a “soft” type user interaction with a touch panel;

FIG. 18 shows an applied force measured based on the piezoelectric pressure signal shown in FIG. 37;

FIG. 19 is a process-flow diagram of an electrode channel updating process;

FIG. 20 shows an example of a measured piezoelectric pressure signal corresponding to a “hard” type user interaction which transitions to a “soft” type user interaction;

FIG. 21 shows an applied force measured based on the piezoelectric pressure signal shown in FIG. 20;

FIG. 22 shows an example of a measured piezoelectric pressure signal corresponding to a “soft” type user interaction which transitions to a “hard” type user interaction;

FIG. 23 shows an applied force measured based on the piezoelectric pressure signal shown in FIG. 22;

FIG. 24 is a process-flow diagram of a first example of a state updating process;

FIG. 25 is a process-flow diagram of a second example of a state updating process; and

FIG. 26 is a process-flow diagram of an output force updating process.

### DETAILED DESCRIPTION

In the following description, like parts are denoted by like reference numerals.

A problem which is encountered in piezoelectric pressure sensing is that the signals generated by applying force to a piezoelectric material are inherently transient. Consequently, output signals from piezoelectric pressure sensors require processing to allow measurement of static or slowly varying applied forces. The methods of the present specification are concerned with improving the accuracy and reliability of forces measured using a piezoelectric based touch panel system, whilst maintaining or improving the speed of processing the piezoelectric pressure signals received from the touch panel.

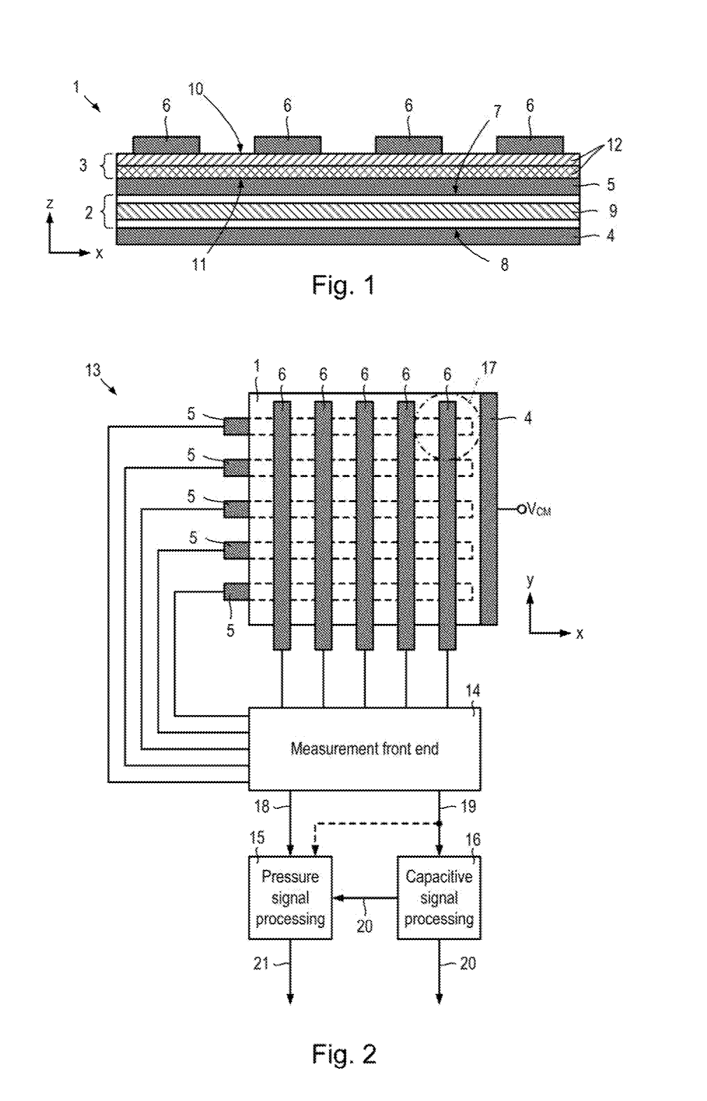

Combined pressure and capacitance touch panel system: Referring to FIG. 1, a simplified cross-section of a touch panel 1 for combined pressure and capacitance measurements is shown.

The touch panel 1 includes first and second layer structures 2, 3, a common electrode 4, a number of first sensing electrodes 5 and a number of second sensing electrodes 6.

The first layer structure 2 has a first face 7 and a second, opposite, face 8. The first layer structure 2 includes one or more layers, including at least a layer of piezoelectric material 9. Each layer included in the first layer structure 2 is generally planar and extends in first and second directions x, y which are perpendicular to a thickness direction z. The one or more layers of the first layer structure 2 are arranged between the first and second faces 7, 8 such that the thickness direction z of each layer of the first layer structure 2 is perpendicular to the first and second faces 7, 8. The first sensing electrodes 5 are disposed on the first face 7 of the first layer structure 2, and the common electrode 4 is disposed on the second face 8 of the first layer structure 2.

Preferably, the piezoelectric layer 9 is formed of a piezoelectric polymer, for example a suitable fluoropolymer such as polyvinylidene fluoride (PVDF). However, the piezoelectric layer may alternatively be formed from a layer of a piezoelectric ceramic such as lead zirconate titanate (PZT).

The second layer structure 3 has a third face 10 and a fourth, opposite, face 11. The second layer structure 3 includes one or more dielectric layers 12. Each dielectric layer 12 is generally planar and extends in first and second directions x, y which are perpendicular to a thickness direction z. The one or more dielectric layers 12 of the second layer structure 3 are arranged between the third and fourth faces 10, 11 such that the thickness direction z of each dielectric layer 12 of the second layer structure 3 is perpendicular to the third and fourth faces 10, 11. The second sensing electrodes 6 are disposed on the third face 10 of the second layer structure 3, and the fourth face n of the second layer structure 3 contacts the first sensing electrodes 5. Alternatively, the first sensing electrodes 5 may be disposed on the fourth face 11.

Preferably, the dielectric layer(s) 12 include layers of a polymer dielectric material such as polyethylene terephthalate (PET) or layers of pressure sensitive adhesive (PSA) materials. However, the dielectric layer(s) 12 may include layers of a ceramic insulating material such as aluminium oxide.

Preferably, the common electrode 4, the first sensing electrodes 5 and/or the second sensing electrodes 6 are formed of indium tin oxide (ITO) or indium zinc oxide (IZO). However, the common electrode 4, the first sensing electrodes 5 and/or the second sensing electrodes 6 may be formed of conductive polymers such as polyaniline, polythiphene, polypyrrole or poly(3,4-ethylenedioxythiophene) polystyrene sulfonate (PEDOT/PSS). The common electrode 4, the first sensing electrodes 5 and/or the second sensing electrodes 6 may take the form of metal films such as aluminium, copper, silver or other metals suitable for deposition and patterning as a thin film. The common electrode 4, the first sensing electrodes 5 and/or the second sensing electrodes 6 may be formed from a metal mesh, nanowires, optionally silver nanowires, graphene, or carbon nanotubes.

Referring also to FIG. 2, a combined pressure and capacitance sensing system 13 is shown.

The combined pressure and capacitance sensing system 13 includes a touch panel 1, a measurement front end 14, a pressure signal processing module 15 and a capacitive signal processing module 16.

The first sensing electrodes 5 each extend in the first direction x and the first sensing electrodes 5 are disposed in an array evenly spaced in the second direction y. The second sensing electrodes 6 each extend in the second direction y and the second sensing electrodes 6 are disposed in an array evenly spaced in the first direction x. The common electrode 4 is extensive such that the common electrode 4 at least partially underlies each of the first and second sensing electrodes 5, 6. The common electrode 4 may be substantially coextensive with the second face 8 of the first layer structure 2. In this way, each intersection 17 of a first sensing electrode 5 with a second sensing electrode 6 may effectively provide a separate touch sensor. Each touch sensor formed by an intersection 17 is both a piezoelectric touch sensor and a capacitive touch sensor.

The touch panel 1 may be bonded overlying the display (not shown) of an electronic device (not shown) which incorporates the combined pressure and capacitance sensing system 13. For example, the combined pressure and capacitance sensing system 13 may be incorporated into a mobile telephone, a tablet computer, a portable or laptop computer, a display, a television, and so forth.

Herein, the term “user interaction” may refer to a user touching or pressing a touch panel 1 or a layer of material overlying a touch panel. A user interaction may involve a user's digit or a stylus (whether conductive or not). A touch interaction may include a user's digit or conductive stylus being proximate to the touch panel 1 without direct physical contact or without applying significant pressure. A press interaction involves a user pressing the touch panel 1 with sufficient force to cause straining of the layer of piezoelectric material 9 and generation of a piezoelectric response. The location of a user interaction may change with time as a user moves a digit or stylus. The touch panel 1 and system 13 support the measurement and tracking of one or more concurrent user interactions, sometimes referred to as “multi-touch” interactions.

The measurement front end 14 performs combined pressure and capacitance measurements on the touch panel 1. The measurement front end 14 measures pressures by detecting the voltages induced between the first sensing electrodes 5 and the common electrode 4 by straining of the piezoelectric layer 9 in response to user interactions applying pressure, and/or voltages induced between the second sensing electrodes 6 and the common electrode 4. In this way, the measurement front end 14 may provide one- or two-dimensional resolved measurements of pressures applied to the touch panel 1 by one or more user interactions. Preferably, pressures are measured by both the first and the second sensing electrodes 5, 6. The measurement front end 14 also measures mutual capacitances for each intersection 17 of the first and second sensing electrodes 5, 6.

The measurement front end 14 may measure piezoelectric pressure signals and capacitances concurrently. For example, the measurement front end 14 may be configured as described in WO 2017/109455 A1, or as described in WO 2016/102975 A2, and the entire contents of both documents are hereby incorporated by reference. In particular, suitable combined pressure and capacitance touch panel systems 13 are shown in, and described with reference to, FIGS. 4 to 23 of WO 2017/109455 A1. Furthermore, suitable combined pressure and capacitance touch panel systems 13 are shown in, and described with reference to, FIGS. 15 to 29 of WO 2016/102975 A2.

The measurement front end 14 outputs pressure signals 18 and capacitance signals 19. The pressure signals 18 correspond to amplified and/or integrated piezoelectric voltages induced between the first sensing electrodes 5 and the common electrode 4 and/or between the second sensing electrodes 6 and the common electrode 4. When the measurement front end 14 measures piezoelectric pressure signals and capacitances concurrently, for example, when the measurement front end 14 is configured as described in WO 2017/109455 A1 or as described in WO 2016/102975 A2, the pressure signals 18 and capacitance signals 19 are obtained by frequency separation of signals corresponding to each sensing electrode 5, 6 to obtain the signals 18, 19. The measurement front end 14 may include a low-frequency cut-off filter configured to reject a pyroelectric response of the layer of piezoelectric material 9. The low frequency cut-off may take a value between 1 Hz and 7 Hz. The measurement front end 14 may include a notch filter configured to reject a mains power distribution frequency, for example, 50 Hz or 60 Hz.

The capacitive signal processing module 16 receives and processes the capacitance signals 19 to determine capacitance information 20 including the number of user interactions and the x-y coordinates of each user interaction. The capacitive signal processing module 16 may function in the same way as a conventional capacitive touch controller, and may be provided by a conventional capacitive touch controller. In some examples, the capacitive signal processing module 16 also provides driving signals for the capacitance measurements to the measurement front end 14. The self-capacitances of the sensing electrodes 5, 6, or the mutual capacitances between any pair of a first sensing electrode 5 and a second sensing electrode 6, may be measured by the capacitive signal processing module 16 according to known methods.

The pressure signal processing module 15 receives the pressure signals 18 and the capacitance information 20, including the number of user interactions and the x-y coordinates of each user interaction. Optionally, the pressure signal processing module 15 may also receive the unprocessed capacitance signals 19. The pressure signal processing module 15 is configured to measure, using the transient pressure signals 18, one or more output forces 21 corresponding to user interactions applying pressure to the touch panel 1. The capacitance information 20 is used in the measurement of output forces 21. Methods of measuring the output forces 21 are explained in detail hereinafter. Optionally, the unprocessed capacitance signals 19 may also be used by the signal processing module is, for example, to contribute to estimating the quality and reliability of signals from a given first or second sensing electrode 5, 6.

Although the first and second sensing electrodes 5, 6 have been shown as being substantially rectangular, any other shapes known for use in projected capacitance touch panels may be used. For example, diamond patterned electrodes may be used for the first and second sensing electrodes 5, 6.

The first layer structure 2 of the touch sensor 1 may include only the layer of piezoelectric material 9, such that the first and second opposite faces 7, 8 are faces of the piezoelectric material layer 9. Alternatively, the first layer structure 2 may include one or more additional dielectric layers (not shown) which are stacked between the layer of piezoelectric material 9 and the first face 7 of the first layer structure 2. The first layer structure 2 may include one or more additional dielectric layers (not shown) stacked between the second face 8 of the first layer structure 2 and the layer of piezoelectric material 9. Preferably, one or more additional dielectric layers (not shown) include layers of a polymer dielectric material such as polyethylene terephthalate (PET), or layers of pressure sensitive adhesive (PSA) material. However, one or more additional dielectric layers (not shown) may include layers of a ceramic insulating material such as aluminium oxide. The one or more additional dielectric layers (not shown) may be similar to the dielectric layers 12 of the second layer structure 3.

The second layer structure 3 may include a single dielectric layer 12, such that the third and fourth opposite faces 10, 11 are faces of a single dielectric layer 12. Alternatively, a second layer structure 3 need not be used, and the second sensing electrodes 6 could instead be disposed on the first face 7 along with the first sensing electrodes 5.

In FIGS. 1 and 2, the first and second faces 7, 8 and the layers of the first and second layer structures 2, 3 are shown extending along orthogonal axes labelled x and y, and the thickness direction of each layer of the first and second layer structures 2, 3 is aligned with an axis labelled z which is orthogonal to the x and y axes. However, the first, second and thickness directions x, y, z need not form a right handed orthogonal set as shown. For example, the first and second directions x, y may intersect at an angle of 30 degrees or 45 degrees or any other angle greater than 0 degrees and less than 90 degrees.

The details of the touch panel 1 and system 13 described hereinbefore and with reference to WO 2017/109455 A1 and WO 2016/102975 A2 are provided for the purposed of understanding the methods of the present specification, but the methods of the present specification are not limited to the touch panel 1 and system 13. The methods of the present specification may be employed with any touch panel system which includes an array of piezoelectric sensors and an array of capacitance sensors.

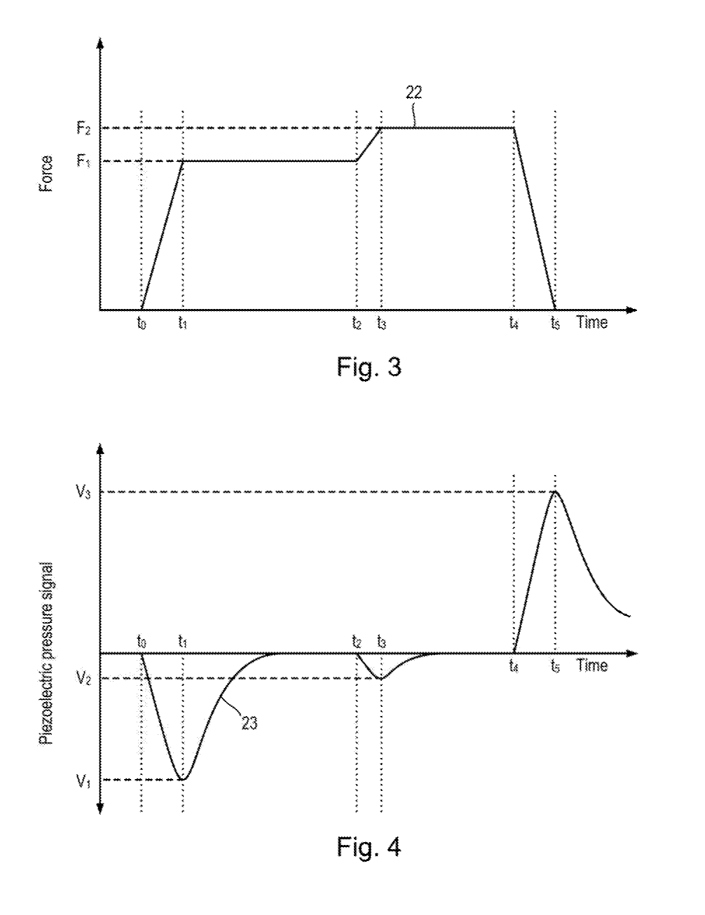

Referring also to FIG. 3 a schematic force input 22 applied to the touch panel 1 is shown.

The layer of piezoelectric material 9 is poled and becomes polarised with a polarisation P in response to straining caused by a user interaction which applies sufficient force. The polarisation P of the layer of piezoelectric material 9 results in a corresponding charge Q_{piezo}(t) being developed between the common electrode 4 and the sensing electrodes 5, 6. The straining which produces the polarisation P may result from a compression or a tension. The straining which produces the polarisation P may be an in-plane stretching of the piezoelectric material layer 9. Intimate contact between the layer of piezoelectric material 9 and the sensing electrodes 5, 6 is not required. Generally, a greater straining of the layer of piezoelectric material 9 (caused by a more forceful user interaction) will result in a greater polarisation P, and a correspondingly larger magnitude of the charge difference ΔQ_{piezo} induced on the sensing electrodes 5, 6. A piezoelectric response I_{piezo}(t), which is the current associated with the charge Q_{piezo}(t), may be amplified and/or integrated to determine a piezoelectric pressure signal 23 (FIG. 4).

Referring also to FIG. 4, an idealised piezoelectric pressure signal 23 corresponding to the force input 22 is shown.

The piezoelectric pressure signal 23, for example as output from and/or amplified by the measurement front end 14, is fundamentally a transient signal. The induced piezoelectric voltages decay with time due to leakage currents. Moreover, the output of an integrating charge amplifier, which may be used to amplify a piezoelectric current I_{piezo}, also decays with time.

For example, during a first loading period, t₀≤t≤t₁, the force 22 increases steadily from zero to a first force value F₁. Provided that the rate of increase of the force 22 is fast compared to the rate of decay of the piezoelectric pressure signal 23, the corresponding piezoelectric pressure signal 23 decreases steadily during the first loading period t₀≤t≤t₁, reaching a first peak value of V₁ as the force 22 reaches the first force value F₁. The force 22 is then held constant at F₁ for a first holding period, t₁<t≤t₂. During the first holding period, t₁<t≤t₂, the piezoelectric pressure signal 23 decays upwards from the first peak value V₁ towards, in the ideal case, zero DC offset.

The force 22 increases again from the first force value F₁ to a second force value F₂ during a second loading period t₂<t≤t₃. Provided that the rate of increase of the force 22 is fast compared to the rate of decay of the piezoelectric pressure signal 23, the corresponding piezoelectric pressure signal 23 decreases steadily during the second loading period t₂<t≤t₃, reaching a second peak value of V₂ as the force 22 reaches the second force value F₂. The force 22 is then held constant at F₂ for a second holding period, t₃<t≤t₄. During the second holding period, t₃<t≤t₄, the piezoelectric pressure signal 23 decays upwards from the second peak value V₂ towards, in the ideal case, zero signal.

At the end of the second holding period, t₃<t≤t₄, the user interactions ends with the release of the force 22 during an unloading period t₄<t≤t₅. Provided that the rate of decrease of the force 22 is fast compared to the rate of decay of the piezoelectric pressure signal 23, the corresponding piezoelectric pressure signal 23 increases steadily during the unloading period t₄<t≤t₅, reaching a third peak value V₃, as the force 22 reaches zero. The third peak value V₃, resulting from unloading rather than loading, has opposite sign to the first and second peak values V₁, V₂. After the end of the user interaction, the piezoelectric pressure signal 23 decays towards, in the ideal case, zero DC offset.

Although FIG. 4 illustrates the piezoelectric pressure signal 23 becoming negative in response to loading and positive in response to unloading, the polarity of the piezoelectric pressure signal 23 may be reversed in other examples, depending on the configuration of the touch panel 1 and system 13.

When the piezoelectric pressure signal 23 is ideal, as illustrated in FIG. 4, the decay of the piezoelectric pressure signal 23 may be compensated for by various methods such as, for example, conditional integration of the piezoelectric pressure signal 23 based on the gradient and/or values of the piezoelectric pressure signal 23. By integrating the piezoelectric pressure signal 23 when the gradient and value of the piezoelectric pressure signal 23 are the same sign, an estimated measurement proportional to the applied force 22 may be recovered.

However, when a touch panel 1 and system 13 for combined pressure and capacitance measurements is used, piezoelectric pressure signals 23 may in practice be subjected to continuous variations in DC offsets and significant sources of noise which may prevent the reliable operation of nave value and gradient based conditional integrations.

Without wishing to be limited by theory or particular, specific, examples, it may be helpful for understanding the present specification to discuss potential sources of DC offset variations and noise for a touch panel 1 and system 13. The touch panel 1 and system 13 may often be installed in a handheld, battery operated device (not shown). Such devices are typically ungrounded, or only weakly grounded, which may increase the susceptibility to noise pickup and to variation in DC offsets. Additionally, a user may frequently become charged with static electricity as a result of interactions between their clothing, footwear and/or their environment. This may further contribute to variations in DC offsets, and may also result in electrostatic discharging between the user's digit and/or stylus upon an initial contact with the touch panel 1. Such electrostatic discharges can apply charges Q_{esd} to the sensing electrodes 5, 6 close to a user interaction which may equal, or even substantially exceed, charges Q_{piezo} resulting from applied forces. Furthermore, short interactions such as tapping a touch panel 1 in rapid succession may confuse gradient and value based approaches because the signal from one tap may not have completely decayed before the next tap commences, leading to inaccurate measurements of forces. The preceding discussion is not exhaustive, and many additional factors may contribute to DC offset variations and noise levels of a touch panel 1 and system 13. Therefore, there is a need for methods of measuring forces applied to a touch panel 1 with improved reliability, without sacrificing sensitivity and/or computational speed.

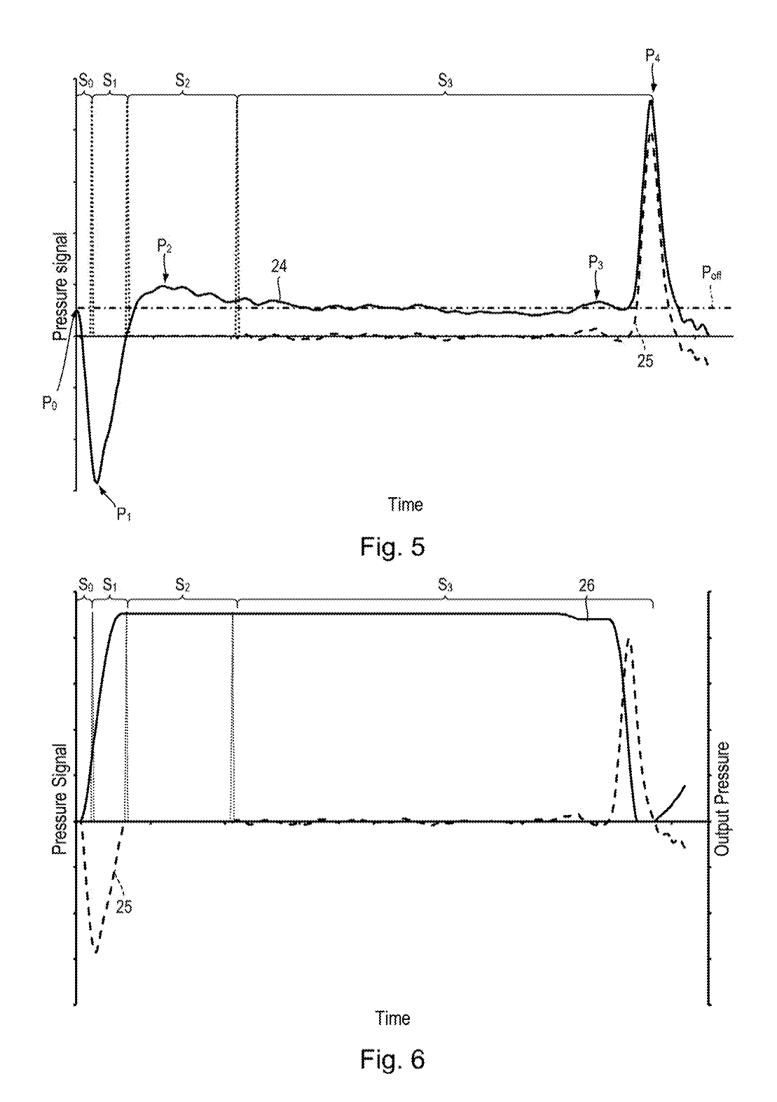

For example, referring also to FIG. 5, an example of a measured piezoelectric pressure signal 24 obtained using an example of the touch panel 1 and system 13 is shown.

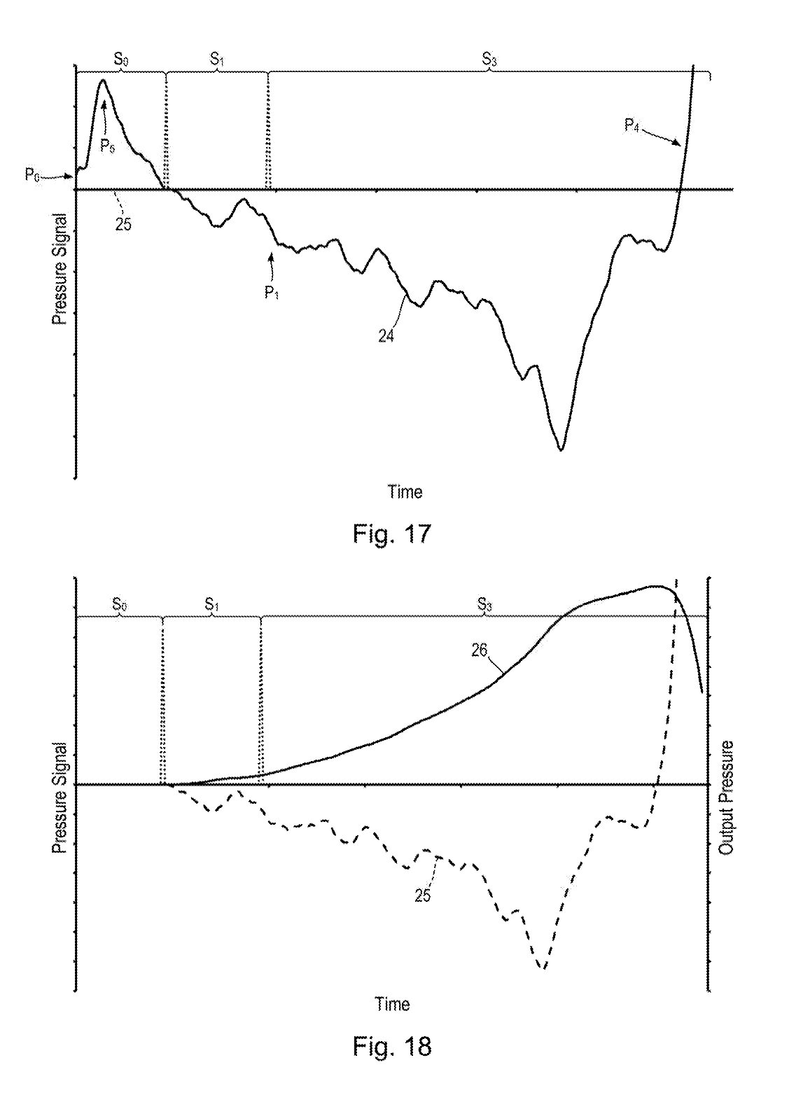

It may be observed that the measured piezoelectric pressure signal 24 deviates from the ideal piezoelectric pressure signal 23 in several important ways. Firstly, the start of the touch event, determined from the capacitance information 20, occurs when the pressure signal 24 values, P(t), are not at zero DC offset. Instead, at a time t=0 with respect to the beginning of the user interaction, the pressure signal 24 values P(t) may often display an initial DC offset value P₀=P(0). This may occur for a variety of reasons such as, for example, a residual DC offset following a prior user interaction, static discharge of a user's digit upon initial contact to the touch panel 1, a repeated touch before signal from a prior user interaction has fully decayed, and so forth. The initial offset P₀ may be significant in practice. When a user's digit undergoes static discharge, the initial offset P₀ may sometimes be accompanied by an initial false peak P₅ (FIG. 17) which is believed to result from electrostatic discharge. Including an initial false peak P₅ (FIG. 17) may result in inaccurate force outputs. However, simply setting gradient and value thresholds to exclude initial offsets P₀ and/or false peaks P₅ (FIG. 17) will cause reduced sensitivity throughout the remainder of the user interaction.

Secondly, after an initial peak P₁ is reached, the pressure signal 24 values P(t) may decay to an offset value P_{off} which is not equal to zero. It has been observed that the offset value P_{off} is generally the opposite sign to the initial peak P₁. It has also been observed that the offset value P_{off} may change after each user interaction with a particular sensing electrode 5, 6, such that conventional DC offset correction and calibration methods may be less effective. Furthermore, the pressure signal 24 values P(t) may, during a proportion of user interactions, display a false peak P₂ during which the pressure signal 24, P(t), overshoots the offset value P_{off} before settling. The magnitude of a false peak P₂ can be significant during some user interactions.

As explained hereinbefore, simply setting gradient and value thresholds to exclude initial offsets and/or electrostatic discharge peaks, offset values P_{off} and false peaks P₂, P₅ (FIG. 17) may cause reduced sensitivity throughout the remainder of the user interaction. This may lead to failing to detect, for example, a small peak P₃ corresponding to a user's slight lift-off of pressure just prior to a main unloading peak P₄.

The methods detailed in the present specification are intended to address such issues by providing methods to measure forces applied to a touch panel 1 which are more robust against variations in DC offsets and other sources of noise, without the need to increase thresholds and reduce sensitivity. At the same time, the methods detailed in the present specification may be efficiently executed by a controller, application specific integrated circuit (ASIC), microcontroller or microprocessor at a speed which is sufficient to avoid introducing excessive latency which might be perceptible by a user. Excessive latency may be annoying to a user or, if the latency becomes too large, it may make providing correct input difficult or impossible.

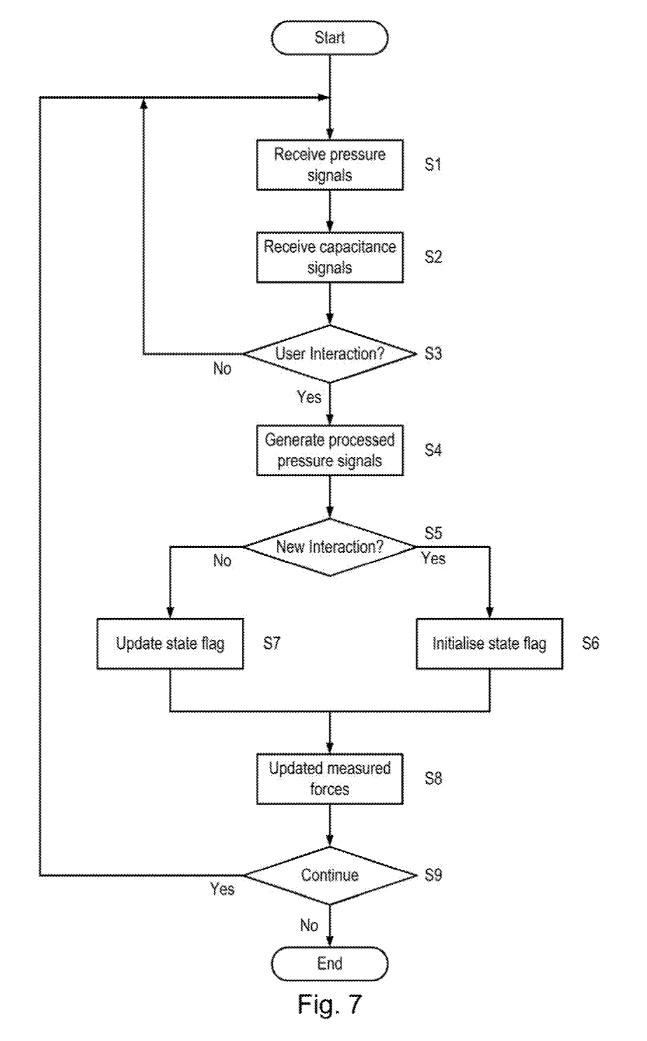

Referring also to FIGS. 6 and 7, the methods of the present specification shall be explained.

Pressure signals 18 are received from a number of piezoelectric sensors supported on or embedded within a touch panel (step S1).

Capacitance signals 19 are received from a number of capacitive touch sensors supported on or embedded within the touch panel (step S2).

For example, the touch panel may be the touch panel 1 for combined pressure and capacitance measurements using a common set of electrodes 4, 5, 6. Alternatively, the touch panel may have a layer including piezoelectric sensors stacked with a separate layer including capacitive touch sensors.

Based on the capacitance signals 19, a user interaction period is determined during which a user interaction with the touch panel occurs (step S3), for example, the period t₀ to t₅ (FIG. 3).

If no user interaction is occurring (step S3), the next sampling of the pressure signals is obtained (step S1).

If a user interaction is occurring (step S3), processed pressure signals are generated based on the received pressure signals (step S4). For example, generating the processed pressure signals may include, for each piezoelectric sensor, subtracting a DC offset value from the received pressure signal. A DC offset value corresponding to each piezoelectric sensor may be initialised after a warm-up period has elapsed following switching on the touch panel. The initial DC offset value is based on the received pressure signals in the absence of a user interaction, for example, based on the mean, median, mode or range of the pressure signals.

Optionally, an additional re-calibration step may be used. For example, for each piezoelectric sensor, the system 13 may maintain a regression buffer of received pressure signal 18 values during periods when there are no user interactions. The gradient and variance of the values stored in the regression buffer may be determined, and in response to the gradient and variance being less than predetermined threshold values, the DC offset value may be updated based on the values stored in the regression buffer. For example, the DC offset value may be corrected based on the mean, median, mode or range of the values stored in the regression buffer.

Generating processed pressure signals may also include filtering the received pressure signals 18.

It is determined whether the received signals correspond to the first sampling of a newly commenced user interaction (step S5), and upon commencing a new user interaction a state register is initialised to a first state value S₀ (step S6).

If the received signals 18, 19 do not correspond to the first sampling of a newly commenced user interaction (step S5), the state register value may be updated (step S7). The user interaction transitions between state register values in dependence upon the current state register value and one or more pressure signal properties. Pressure signal properties may include one or more of a signal value, a signal gradient, a signal variance or standard deviation, a signal range, a signal minimum, a signal maximum, a time elapsed since the start of the user interaction period, a time elapsed since the state register value was changed, a time elapsed since detecting a peak in the pressure signal, and so forth. Pressure signal properties may include comparing a signal value, a signal gradient, a signal variance or standard deviation, a signal range, a signal minimum or a signal maximum against one or more corresponding predetermined thresholds or ranges.

In one example, the state register may be set to one of four values S₀, S₁, S₂ or S₃. The state register may be changed from the first state value S₀ to the second state value S₁ in response to a time elapsed since the start of the user interaction exceeding a minimum duration and the processed pressure signal having a sign corresponding to an increasing force. The state register may be changed from the second state value S₁ to the third state value S₂ in response to the processed pressure signal having a sign corresponding to a decreasing force. The state register may be changed from the third state value S₂ to the fourth state value S₃ in response to the, processed pressure signal having a signal gradient below a signal gradient threshold.

Although in this example the transitions between the four states S₀, S₁, S₂, S₃ are linear, the method of allowing state transitions to depend also on the present value of the state register supports hierarchical, non-linear and/or branching sequences of values for the state register. This may allow reliability of pressure signal processing to be improved without sacrificing sensitivity, because the behaviour of signal processing may be made highly dependent on the prevailing conditions of a user interaction.

Measurements of the force applied to each of the plurality of piezoelectric sensors by the user interaction are updated (step S8). During the user interaction, the forces are measured by conditionally integrating the corresponding processed pressure signals according to the value of the state register corresponding to the user interaction. The integrating may be implemented using numerical means such as, for example, simple summation, application of the trapezium rule, and so forth.

In an example for which the state register may be set to one of four values S₀, S₁, S₂ or S₃, each value of the state register S₀, S₁, S₂, S₃ may be set to correspond to different behaviour for integrating the processed pressure values.

For example, if the state register corresponds to the first state value S₀, processed pressure signal values having a sign corresponding to an increasing force may be integrated and processed pressure signal values corresponding to a decreasing force may be not integrated. If the state register corresponds to the second state value S₁, all processed pressure signal values may be integrated. If the state register corresponds to the third state value S₂, processed pressure signal values may be not integrated. If the state register corresponds to the fourth state value S₄, processed pressure signal values which exceed a noise threshold may be integrated whilst processed pressure signal values which do not exceed the noise threshold may be not integrated.

Whilst the touch panel system continues to operate (step S9), the next sampling of the pressure signals is obtained (step S1).

In this way, since the transitions between state register values depend also upon the current value of the state register, pressure signals may be processed in a more responsive manner, which may enable improvements in the reliability of the measured forces.

State register values may be set separately for each of the plurality of piezoelectric sensors. Alternatively, state register values may be set for each user interaction, so that set of adjacent piezoelectric sensors may use a common state register when they are all influenced by the same user interaction.

The method supports multiple, concurrent user interactions with a touch panel.

Referring now in particular to FIGS. 5 and 6, application of one implementation of the method to the measured pressure signal 24 shown in FIG. 5 will be described.

As the user interaction progresses, the pressure signal processing module 15 updates a state register value between at least 4 distinguishable states, S₀, S₁, S₂ and S₄ (step S7). The boundaries of and transitions between states S₀, S₁, S₂ and S₃ are indicated in FIGS. 5 and 6 for reference. In this example, the state register may be set to one or four values S₀, S₁, S₂ and S₄. The measured piezoelectric pressure signal 24 values P(t) are processed according to the methods of the present specification to determine a processed pressure signal 25 (step S4), which is in turn used to measure the output force 26 (step S8). In FIG. 6, the output force 26 is plotted against the secondary y-axis.

When the user interaction begins, which is determined based on the capacitance information 20 (step S3), the user interaction is initialised into a first, or initial state S₀ (step S6). In this example, during the initial state S₀, the pressure signal 24 values P(t) are not used unless they have the appropriate sign for increasing load on the touch panel 1. For the examples shown in FIGS. 5 and 6, the appropriate sign is negative, but in other examples the pressure signal 24 values P(t) may increase in response to increasing applied force. In practice, this condition may be applied by generating processed pressure signal 25 values P*(t), according to:

$${P}^{*} ( t ) = \{ \begin{matrix}P ( t ) & if sign [ P ( t ) ] \\ 0 & otherwise\end{matrix} \}$$

During the initial state S₀, an output force signal F(t) is obtained for each new sampling of the pressure signal 24 value P(t) by adding the corresponding processed signal 25 value P*(t) to the previous value of the output force signal, i.e. F(t)=F(t−1)+P*(t) (step S8). Since the processed signal 25 value P*(t) is set to zero when the pressure signal 24 value P(t) has the wrong sign for increasing applied force, these values do not contribute to the output force signal F(t).

Note that the output force signal 26 values F(t) are proportional to applied force, but to obtain an estimated measurement of absolute applied force, the measured values F(t) will need to be multiplied by corresponding scale factors. The scale factor may be obtained from calibration experiments using known applied force profiles. Scale factors may further depend on the location of a user interaction with the touch panel 1.

The transition to a second, primary loading, state S₁ may occur once a predetermined duration has elapsed since the start of the user interaction (step S7). The start of the user interaction is known with good accuracy from the capacitance information 20. During the primary loading state S₁, all sample pressure signal 24 values P(t) may be used unconditionally, i.e. the processed signal may be set as P*(t)=P(t) (step S4) and the output force signal F(t) may updated as F(t)=F(t−1)+P*(t) (step S8).

The transition to a third, or settling, state S₂ may occur when the pressure signal 24 values P(t) change sign, or when the pressure signal processing module 15 has conclusively detected the initial loading peak P₁ (step S7). In the example shown in FIGS. 5 and 6, the state transition S₁ to S₂ occurs because the pressure signal 24 values P(t) have changed sign from negative to positive. Of course, in other examples where increasing the applied force causes the pressure signal 24 to increase, the transition is detected in the opposite direction. An example process for determining the approximate time and value of initial peak P₁ is described hereinafter. During the settling state S₂, the pressure signal 24 values P(t) may be not used (step S8), for example by setting the processed signal values P*(t) as P*(t)=0 (step S4). Thus, in FIGS. 5 and 6, it may be observed that in this example the processed signal P*(t) clamps to zero during the false overshoot peak P₂.

The transition to a fourth, or stable state S₃ may occur once the pressure signal 24 values P(t) have stabilised at a DC offset P_{off} (step S7). In general, the DC offset P_{off} may change slowly with time and/or following each loading/unloading peak of the pressure signal 24 values P(t). In some examples the pressure signal processing module 15 maintains a buffer of a number, N_{buff} of previous pressure samples {P(t), P(t−1), . . . , P(t−N_{buff}+1)}, in which context t, t−1, t−N_{buff} are integers indicating sampling times. When each new pressure sample P(t) is obtained, the pressure signal processing module 15 calculates a linear regression on the buffered samples {P(t), P(t−1), . . . , P(t−N_{buff}+1)}. Once the magnitude of the slope, m, and the variance value, VAR, of the buffered pressure signal 24 samples {P(t), P(t−1), . . . , P(t−N_{buff}+1)} are below pre-calibrated thresholds m_{stable}, VAR_{stable}, the pressure signal processing module 15 updates the state register value to the stable state S₃ and sets the mean value of the buffered samples {P(t), P(t−1), . . . , P(t−N_{buff}+1)} as a offset correction value P_{cor}=mean({P(t), P(t−1), . . . , P(t−N_{buff}+1)}).

During the stable state S₃, the processed signal 25 sample P*(t) may be set according to P*(t)=P(t)−P_{cor} (step S4). The output force signal 26 values F(t) may then updated according to (step S8):

$$F ( t ) \{ \begin{matrix}F ( t - 1 ) + P * ( t ) & if \vert P * ( t ) ) \vert > {P}_{noise} \\ F ( t - 1 ) ) & if \vert P * ( t ) ) \vert \leq {P}_{noise}\end{matrix} \}$$

In which Pₙₒᵢₛₑ is a noise threshold. For example, Pₙₒᵢₛₑ may be set to a multiple of the standard deviation of the pressure signal 24 values P(t) during a calibration period in which there are no user interactions. The noise threshold Pₙₒᵢₛₑ may be set to a multiple of five time the standard deviation of the pressure signal 24 values P(t) recorded during a calibration period. The noise threshold Pₙₒᵢₛₑ may be pre-set, or may be periodically updated during quiet periods in which there are no user interactions detected in the capacitive information 20.

Changes in user pressure may be captured during the stable state S₃ with high sensitivity, whether they are increases or decreases in applied force. In the example shown in FIGS. 5 and 6, the small peak P₃ corresponding to a slight reduction in applied pressure is detected and the output force signal 26 values F(t) are correspondingly decreased.

During the stable state S₃, the threshold for detecting a change in the force applied to the touch panel 1 may be set to a lower value than would be possible for a conventional gradient and value based conditional integration applied to an entire signal. This is because effects such as static discharge, initial offset P₀, overshoot offset P_{off} and false peaks P₂ may screened out through the use of the other state register values S₀, S₁ and S₂. In this way, the methods of the present specification may allow improved reliability during and immediately after the initial contact of the user's digit or conductive stylus with the touch panel 1, as well as sensitive detection of relatively small user modulations of the applied force during the main part of a user interaction.

In practice, the required offset correction P_{cor} may slowly drift whilst a user maintains constant pressure. Additionally, if a user substantially increases or decreases applied pressure, this may change the offset P_{off} to which the piezoelectric pressure signal 24 values P(t) decay. However, the correction value P_{cor} cannot simply be updated continuously whilst the buffer {P(t), P(t−1), . . . , P(t−N_{buff}+1)} remains relatively flat (i.e. m<m_{stable} and VAR<VAR_{stable}). If this was the case, any slight increase or decrease of the applied pressure would be continuously removed from the processed pressure 25 samples P*(t), and would therefore not be detected.

Instead, during the stable state S₃ the pressure signal processing module 15 may perform linear regression on the buffer {P(t), P(t−1), . . . , P(t−N_{buff}+1)} after each new sampling P(t). Whilst the buffer {P(t), P(t−1), . . . , P(t−N_{buff}+1)}) remains flat (i.e. m<m_{stable} and VAR<VAR_{stable}), the mean value of the buffered samples is compared against the correction value P_{cor} and, if the magnitude of the difference |mean({P(t), P(t−1), . . . , P(t−N_{buff}+1)})−P_{cor}|, is less than a threshold value ΔP_{cor}, then the correction value P_{cor} is unchanged. However, if the difference, |mean({P(t), P(t−1), . . . , P(t−N_{buff}+1)})−P_{cor}|, exceeds the threshold value ΔP_{cor}, then the correction value is updated to P_{cor}=mean({P(t), P(t−1), . . . , P(t−N_{buff}+1)}).

The value of the threshold ΔP_{cor} may vary for each touch panel 1 and system 13. A suitable value for a given touch panel 1 and system 13 may be obtained by measuring data corresponding to a selection of known calibration force profiles. In a simple case, the threshold ΔP_{cor} may be set according the largest drift observed over the duration of a known, static applied force. Alternatively, the measurements obtained using known calibration force profiles may be used to generate a training set for a fitting, using the deviation of the known and measured forces as a cost function.

The stable state S₃ ends at the end of the user interaction.

In some examples, described further hereinafter, it may be useful to make a distinction between user interactions which begin with a clear increase in pressure to the initial loading peak P₁, referred to herein as “hard” type user interactions, and other user interactions in which the pressure increases more gradually to the initial loading peak P₁, referred to herein as “soft” type user interactions. In some “soft” type user interactions, when applied force is increased very gradually, a well defined initial loading peak P₁ may not be observed. The extension of the method to include differentiated processing of “hard” and “soft” type user interactions is described hereinafter.

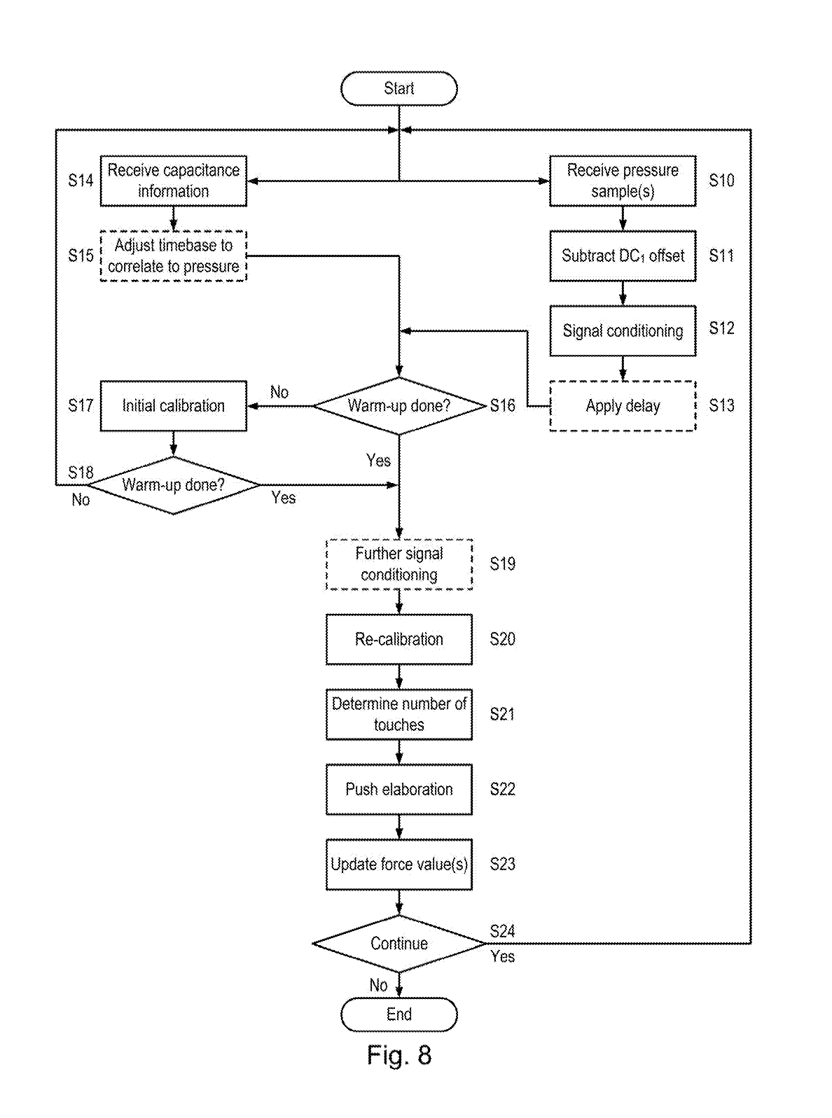

Example of implementing the method: Referring also to FIG. 8, a process flow diagram of an example processing chain for implementing a method according to the present specification is shown. The methods of the present specification are not limited to the steps illustrated in FIG. 8 and subsequent Figures illustrating further details of particular signal processing steps.

The pressure signal processing module 15 receives pressure signal 18 values P(t) corresponding to the first and second sensing electrodes 5, 6 (step S10). The pressure signal 18 values P(t) for each first and second sensing electrodes 5, 6 may all be received concurrently. Alternatively, the pressure signal 18 values P(t) corresponding to the first and second sensing electrodes 5, 6 may be received sequentially as each pair of first and second electrodes 5, 6 is read out according to a predetermined or dynamically determined sequence. In general, one pressure signal 18 value P(t) is obtained for each first or second sensing electrode 5, 6 during each sampling period. For example, if there are a number N of first sensing electrodes 5 oriented as shown in FIGS. 1 and 2 and spaced in the second, y direction at coordinates y₁, y₂, . . . , y_{N}, then the corresponding set of pressure samples at a sampling time t may be denoted as {P(t,y₁), P(t,y₂), . . . , P(t,y_{N})}. The set {P(t,y₁), P(t,y₂), . . . , P(t,y_{N})} may be received by the pressure signal processing module 15 either concurrently or sequentially. Similarly, the pressure signal processing module 15 concurrently or sequentially receives a set of pressure samples {P(t,x₁), P(t,x₂), . . . , P(t,x_{M})} from a number M of second sensing electrodes 6 oriented as shown in FIGS. 1 and 2, and spaced in the first, x direction at coordinates x₁, x₂, . . . , x_{M}.

When the pressure samples {P(t,y₁), P(t,y₂), . . . , P(t,y_{N})}, {P(t,x₁), P(t,x₂), . . . , P(t,x_{M})} are received concurrently, the meaning of the sampling time index t is clear, this represents the time at which the corresponding samples were obtained, t−1 is the previous sampling, t+1 the subsequent sampling, and so forth. When the pressure samples {P(t,y₁), P(t,y₂), . . . , P(t,y_{N})}, {P(t,x₁), P(t,x₂), . . . , P(t,x_{M})} are obtained sequentially, the index t refers to one cycle of reading out the sensing electrodes 5, 6. For example, the touch panel 1 is read out to obtain the sets of pressure samples {P(t,y₁), P(t,y₂), . . . , P(t,y_{N})}, {P(t,x₁), P(t,x₂), . . . , P(t,x_{M})}, and then when the scanning repeats, the subsequent sets of pressure samples {P(t+1,y₁), P(t+1,y₂), . . . , P(t+1,y_{N})}, {P(t+1,x₁), P(t+1,x₂), . . . , P(t+1,x_{M})} are obtained, and so forth.

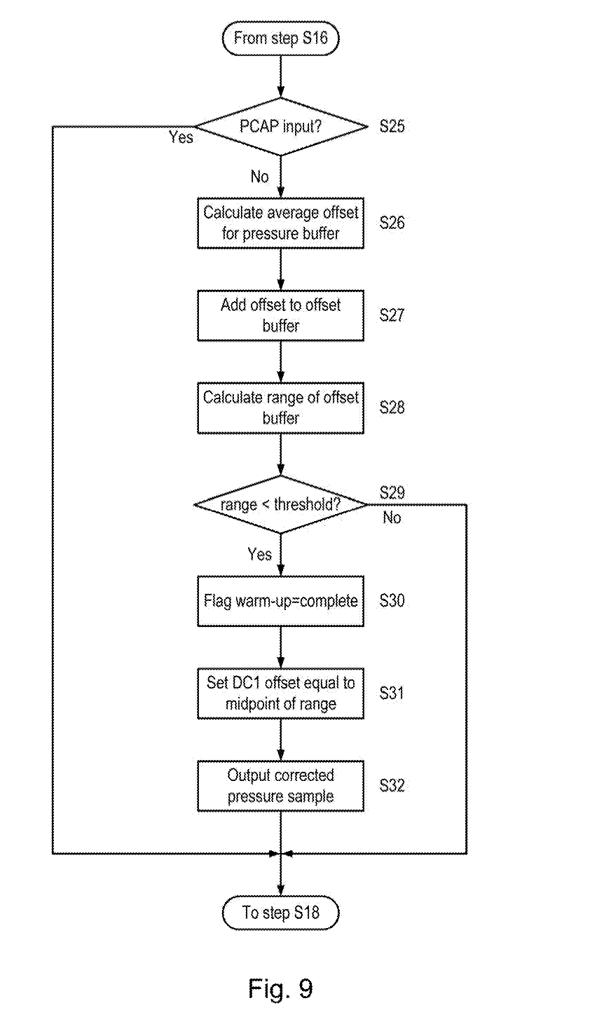

A coarse DC offset correction is performed by subtracting a first DC offset DC₁ from each pressure sample {P(t,y₁), P(t,y₂), . . . , P(t,y_{N})}, {P(t,x₁), P(t,x₂), . . . , P(t,x_{M})} (step S11). In general, each sensing electrode 5, 6 may have a different first offset value, forming sets {DC₁(y₁), DC₁(y₂), . . . , DC₁(y_{N})} and {DC₁(x₁), DC₁(x₂), . . . , DC₁(x_{M})}. The first offsets DC₁ are determined during a warm-up phase when the touch panel 1 and system 13 are powered up, and this process is described further hereinafter (FIG. 9).

The pressure samples {P(t,y₁), P(t,y₂), . . . , P(t,y_{N})}, {P(t,x₁), P(t,x₂), . . . , P(t,x_{M})} are processed according to a signal conditioning step which may include processes such as filtering, decimation, and so forth (step S12). A buffer of previously received pressure samples, {P(t−1,y₁), P(t−1,y₂), . . . , P(t−1,y_{N})}, {P(t−1,x₁), P(t−1,x₂), . . . , P(t−1,x_{M})} may be maintained for use in applying time domain filters.

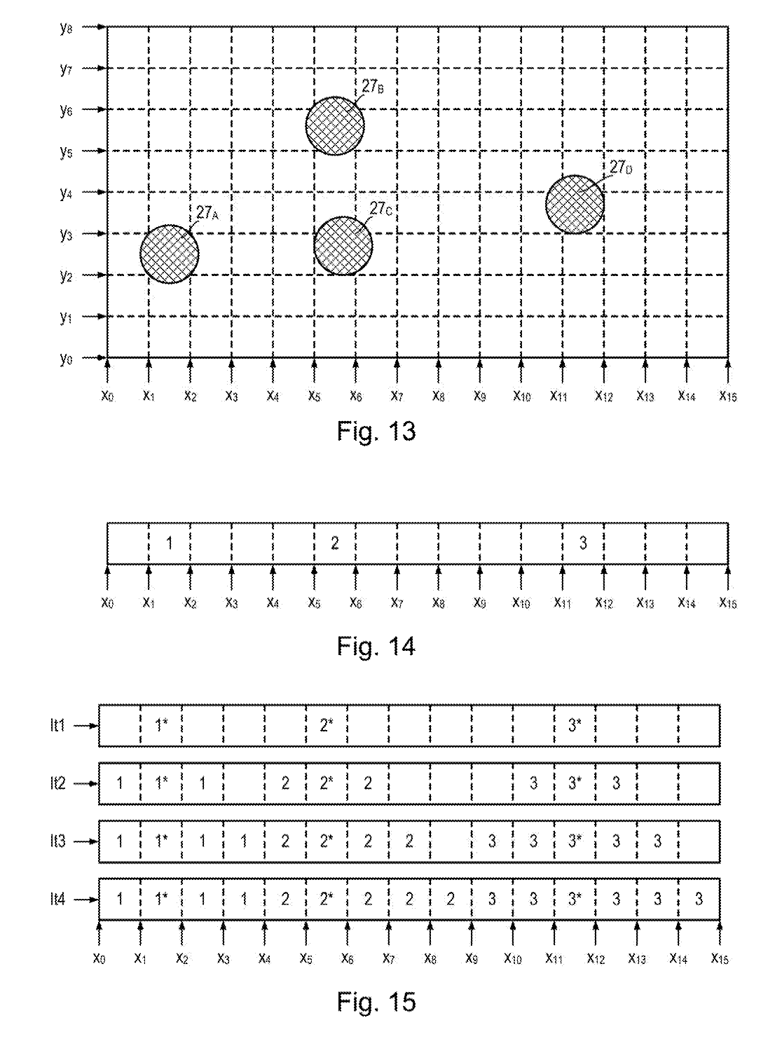

If necessary, the pressure samples {P(t,y₁), P(t,y₂), . . . , P(t,y_{N})}, {P(t,x₁), P(t,x₂), . . . , P(t,x_{M})} are buffered and delayed until synchronised with the received capacitance information 20 (step S13). The capacitance information 20 is used by the, methods of the present specification, for example, to indicate the number, start times, end times, and locations of one or more user interactions 27 (FIG. 13). However, there may often be a propagation and processing delay before the capacitance information 20 is available from the capacitive signal processing module 16. The delay applied to the pressure samples {P(t,y₁), P(t,y₂), . . . , P(t,y_{N})}, {P(t,x₁), P(t,x₂), . . . , P(t,x_{M})} is determined to enable re-synchronisation with the capacitance information 20 for onward processing. The delaying (step S13) may not be necessary if the propagation and processing delay before the capacitance information 20 is available is less than one sampling period of the touch panel 1.

As well as receiving the pressure signals 18, the pressure signal processing module 16 also receives the capacitance information 20 which is output from the capacitive signal processing module 16 (step S14). The capacitance information 20 includes information about whether user interactions 27 (FIG. 13) have been detected by the capacitive signal processing module 16, and a corresponding x-y coordinate on the touch panel for each detected user interaction. Preferably, the pressure signal processing module 16 supports multi-touch detection of two or more user interactions 27 (FIG. 13) concurrently.

Optionally, if the sampling periods of the capacitance information 20 and the sets of pressure samples {P(t,y₁), P(t,y₂), . . . , P(t,y_{N})}, {P(t,x₁), P(t,x₂), . . . , P(t,x_{M})} are not equal, the timebase for the capacitance information 20 may be converted to match that of the pressure samples {P(t,y₁), P(t,y₂), . . . , P(t,y_{N})}, {P(t,x₁), P(t,x₂), . . . , P(t,x_{M})} (step S15).

The pressure signal processing module 15 checks whether a warm-up period following initially powering up the touch panel 1 and system 13 has finished (step S16). The end of the warm-up period need not occur a fixed or pre-determined period after switching on the touch panel 1 and system 13. Instead, the pressure signal processing module 15 sets a warm-up flag to a value of “complete” when the calibration procedure (step S17) has determined that the touch panel 1 and system 13 have reached stable operation.

The pressure signal processing module 15 performs an initial calibration procedure to determine whether or not the pressure samples {P(t,y₁), P(t,y₂), . . . , P(t,y_{N})}, {P(t,x₁), P(t,x₂), . . . , P(t,x_{M})} have reached a stable DC offset value (step S17). If the pressure samples {P(t,y₁), P(t,y₂), . . . , P(t,y_{N})}, {P(t,x₁), P(t,x₂), . . . , P(t,x_{M})} have reached a stable DC offset value, the warm-up flag is set to “complete”. The pressure samples {P(t,y₁), P(t,y₂), . . . , P(t,y_{N})}, {P(t,x₁), P(t,x₂), . . . , P(t,x_{M})} corresponding to all of the sensing electrodes 5, 6 should reach a stable DC offset value before the warm-up period is flagged as “complete”. Once this condition has been met for all sensing electrodes 5, 6, the corresponding sets of first DC offset values {DC₁(y₁), DC₁(y₂), . . . , DC₁(y_{N})} and {DC₁(x₁), DC₁(x₂), . . . , DC₁(x_{M})} are obtained. An example of the initial calibration procedure is explained in further detail hereinafter (see FIG. 9).

If the warm-up flag is set to “complete” (step S18), onward processing of the current sets of pressure samples {P(t,y₁), P(t,y₂), . . . , P(t,y_{N})}, {P(t,x₁), P(t,x₂), . . . , P(t,x₁)} is carried out (step S19). Otherwise, the pressure signal processing module 15 obtains the next sets of pressure samples {P(t+1,y₁), P(t+1,y₂), . . . , P(t+1,y_{N})}, {P(t+1,x₁), P(t+1,x₂), . . . , P(t+1,x_{M})} (step S10) and capacitance information (step S14).

Optionally, further signal conditioning may be applied to the pressure samples {P(t,y₁), P(t,y₂), . . . , P(t,y_{N})}, {P(t,x₁), P(t,x₂), . . . , P(t,x_{M})} (step S19). For example, a moving average filter may be applied. A buffer of previously received pressure samples, {P(t−1,y₁), P(t−1,y₂), . . . , P(t−1,y_{N})}, {P(t−1,x₁), P(t−1,x₂), . . . , P(t−1,x_{M})} may be maintained for use in applying filters. Additionally or alternatively, the further signal conditioning may be performed at a different point of the process (e.g. between step S20 and step S21).

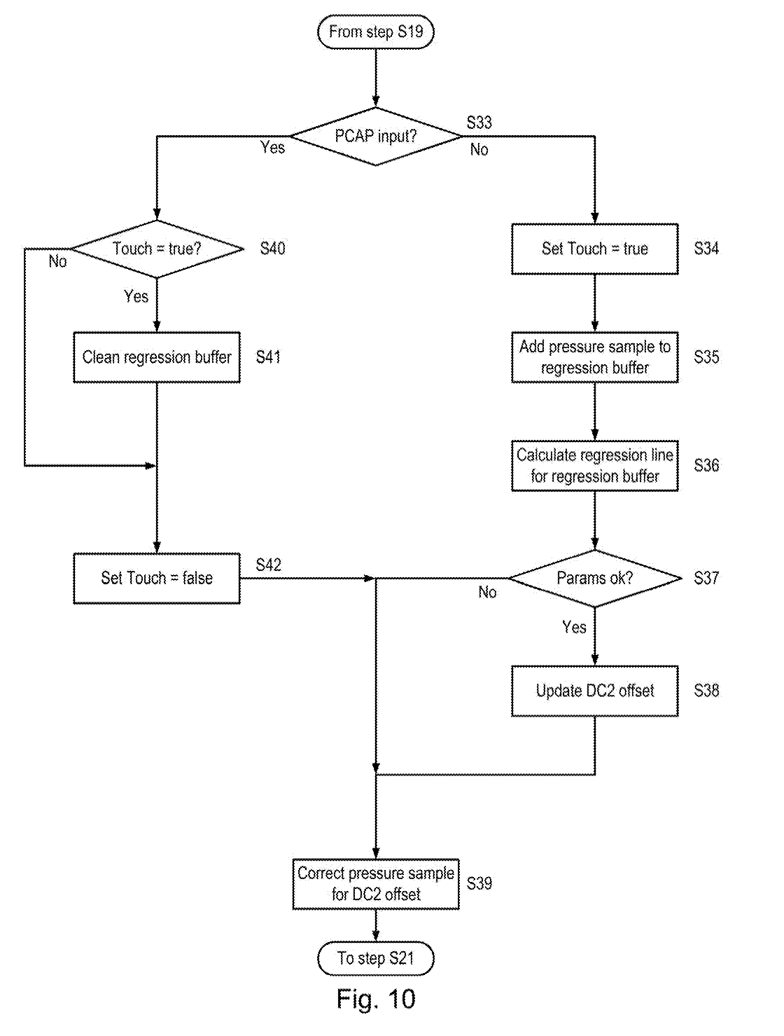

The first DC offsets DC₁ are accurate following the initial calibration, however, as explained hereinbefore the DC offsets for the pressure signals 18 may vary slightly over time and may also change following or during user interactions 27 (FIG. 13). During idle periods when there are no user interactions 27 (FIG. 13) detected from the capacitance information 20, a re-calibration process is conducted to determine an additional second, or fine, DC offset value DC₂ (step S20). The second DC offset values DC₂ are subtracted from each pressure sample {P(t,y₁), P(t,y₂), . . . , P(t,y_{N})}, {P(t,x₁), P(t,x₂), . . . , P(t,x_{M})}. In general, each sensing electrode 5, 6 may correspond to a different second offset value, forming sets {DC₂(y₁), DC₂(y₂), . . . , DC₂(y_{N})} and {DC₂(x₁), DC₂(x₂), . . . , DC₂(x_{M})}. An example of a re-calibration process is further described hereinafter (FIG. 10).

Based on the capacitance information 20, a number N_{touch} of active user interactions 27 (FIG. 13) is determined (step S21). The maximum number of concurrently active user interactions 27 (FIG. 13) depends on the capabilities of the capacitive signal processing module 16 and may be, for example, between one and ten user interactions 27 (FIG. 13).

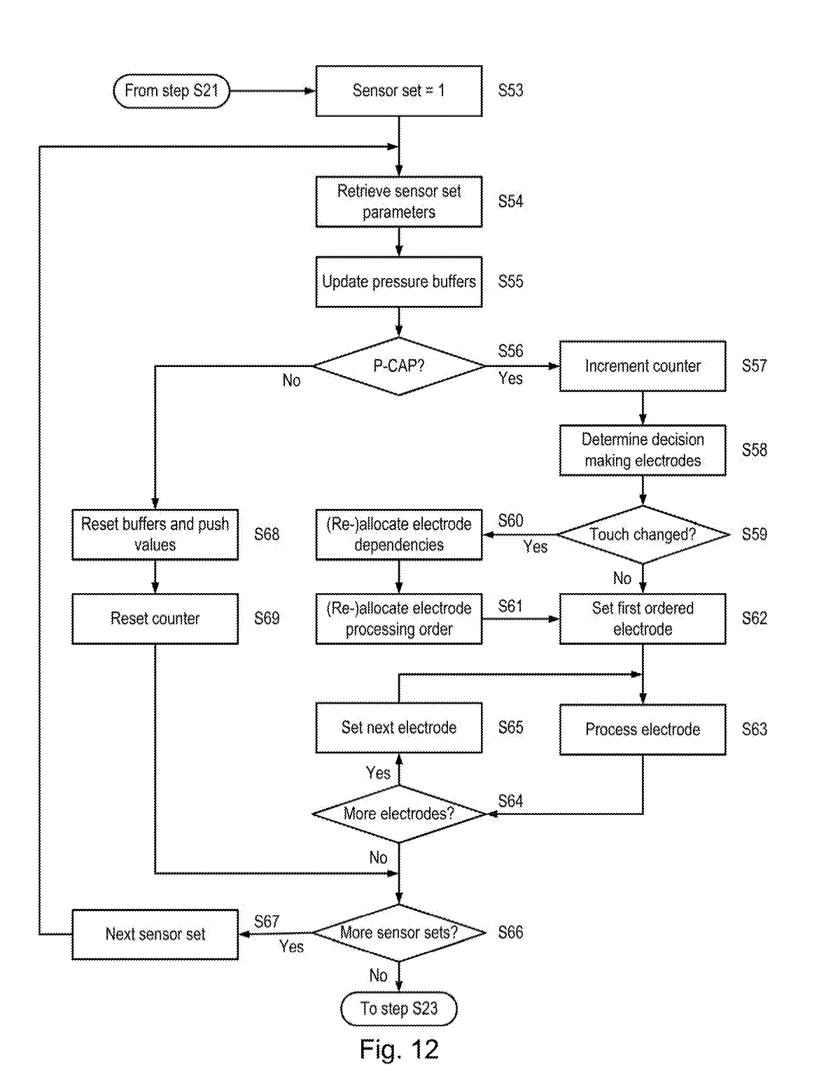

The current pressure samples {P(t,y₁), P(t,y₂), . . . , P(t,y_{N})}, {P(t,x₁), P(t,x₂), . . . , P(t,x_{M})}, and buffered, previously received pressure samples, {P(t−1,y₁), P(t−1,y₂), . . . , P(t−1,y_{N})}, {P(t−1,x₁), P(t−1,x₂), . . . , P(t−1,x_{M})}, and so forth, are analyse to determine state register values S₀, S₁, S₂, S₃ (and optionally user interaction types) corresponding to each sensing electrode 5, 6 (step S22). The output processed pressure samples {P*(t,y₁), P*(t,y₂), . . . , P*(t,y_{N})}, {P*(t,x₁), P*(t,x₂), . . . , P*(t,x_{M})} are also finalised. This process is referred to herein as “push elaboration”, and an example is further described hereinafter (FIG. 12).

Depending upon the state register value S₀, S₁, S₂, S₃ as described hereinbefore, measured output force 26 values F(t) are updated (step S23). The output forces 26 are measured separately for each first sensing electrode 5 forming a first set {F(t,y₁), F(t,y₂), . . . , F(t,y_{N})}, and for each second sensing electrode 6 forming a second set {F(t,x₁), F(t,x₂), . . . , F(t,x_{N})}.

For as long as the force sensing capability of the touch panel 1 and system 13 is active (step S24), the pressure signal processing module 15 will continue by receiving the next sets of measured pressure samples {P(t,y₁), P(t,y₂), . . . , P(t,y_{N})}, {P(t,x₁), P(t,x₂), . . . , P(t,x_{M})} (step S10) and the corresponding capacitance information 20 (step S14).

Initial calibration: Referring also to FIG. 9, a process-flow diagram of an example initial calibration process (step S17) is shown.

The initial calibration process (step S17) is carried out when it is determined that the pressure signal processing module 15 has not yet flagged the warm-up stage as “complete” (step S16).

The capacitance information 20 is checked to determine whether the capacitive signal processing module 16 has detected any user interactions 27 (FIG. 13) (step S25). If there are any user interactions 27 (FIG. 13) occurring, the initial calibration is not performed (step S18). Although the calibration is performed separately for each sensing electrode 5, 6, the calibration requires that no user interactions 27 (FIG. 13) be occurring anywhere on the touch panel 1, because plate bending of the touch panel 1 will in general apply strains all across the piezoelectric layer 9. This would interfere with obtaining data corresponding to zero-signal conditions.

Provided that there are no active user interactions 27 (FIG. 13) (step S25), the pressure signal processing module 15 calculates, for each sensing electrode 5, 6, the mean value of a number, N_{buf2}, of the most recent pressure samples stored in a calibration buffer (step S26). For example, for the n^{th} of N first sensing electrodes 5, the pressure signal processing module 15 calculates a corresponding offset value OFF(t,yₙ)=mean({P(t,yₙ), P(t−1,yₙ), . . . , P(t−N_{buf2}+1,yₙ)}). In this way, a set of offset values {OFF(t, y₁), OFF(t, y₂), . . . , OFF(t, y_{N})} corresponding to each of the first sensing electrodes 5 are obtained, and a set of offset values {OFF(t, x₁), OFF(t, x₂), . . . , OFF(t, x_{M})} corresponding to each of the second sensing electrodes 6 are also obtained.

The offset values {OFF(t, y₁), OFF(t, y₂), . . . , OFF(t, y_{N})}, {OFF(t, OFF(t, x₁), OFF(t, x₂), . . . , OFF(t, x_{M})} are added to an offset buffer which holds a number, N_{buf3}, of the most recently obtained offset values (step S27).

For each sensing electrode 5, 6, the range of the corresponding offset values stored in the offset buffer is determined (step S28). For example, for the n^{th} of N first sensing electrodes 5, the pressure signal processing module 15 calculates the range of the set of corresponding offset values as RANGE({OFF(t, yₙ), OFF(t−1, yₙ), . . . , OFF(t−N_{buf3}+1, yₙ)}).

For each sensing electrode 5, 6, the corresponding range of the offset buffer is checked against a predetermined range threshold P_{range} (step S29). If any of the determined ranges are greater than or equal to the predetermined range threshold P_{range}, then the warm-up stage is not yet complete and the warm-up flag is left set as “incomplete”. The range threshold P_{range} may be determined from calibration experiments in which the system 13 is powered on and data recorded until a stable state is reached. Statistics of the pressure signals 18 in the absence of user interactions 27 (FIG. 13) may be used to determine the range threshold P_{range}. The range threshold P_{range} may be set individually for each sensing electrode 5, 6.

However, if all of the determined ranges are less than the predetermined range threshold P_{range}, then the warm-up flag is set to a value of “complete” (step S30).

The DC₁ offset values corresponding to each sensing electrode 5, 6 are set based on the mid-points of the respective offset buffers (step S31). For example, the DC₁ offset corresponding to the n^{th} of N first sensing electrodes 5, is calculated as DC₁(yₙ)=0.5*(MAX({OFF(t, yₙ), OFF(t−1, yₙ), . . . , OFF(t−N_{buf3}+1, yₙ)})+MIN({OFF(t, yₙ), OFF(t−1, yₙ), . . . , OFF(t−N_{buf3}+1, yₙ)}), and so forth for each other sensing electrode 5, 6.

The pressure samples {P(t,y₁), P(t,y₂), . . . , P(t,y_{N})}, {P(t,x₁), P(t,x₂), . . . , P(t,x_{M})} are each adjusted for DC offset by subtracting the respective DC₁ offset values {DC₁(y₁), DC₁(y₂), . . . , DC₁(y_{N})}, {DC₁(x₁), DC₁(x₂), . . . , DC₁(x_{M})} (step S32). The terminology of, for example, P(t,yₙ) is also used to refer to the pressure samples following adjustment for DC₁ offset.

First re-calibration process: Referring also to FIG. 10, a process-flow diagram of a first example re-calibration process (step S20) is shown.

The capacitance information 20 is checked to determine whether the capacitive signal processing module 16 has detected any user interactions 27 (FIG. 13) (step S33). Although the re-calibration is performed separately for each sensing electrode 5, 6, the re-calibration requires that no user interactions 27 (FIG. 13) be occurring anywhere on the touch panel 1, because plate bending of the touch panel will in general apply strains across the piezoelectric layer 9. This would interfere with obtaining data corresponding to zero-signal conditions.

Provided that there are no active user interactions 27 (FIG. 13) (step S33), the pressure signal processing module 15 sets a touch flag to a value of “true” (step S34) and adds the sets of pressure samples {P(t,y₁), P(t,y₂), . . . , P(t,y_{N})}, {P(t,x₁), P(t,x₂), . . . , P(t,x_{M})} to a regression buffer which stores a number, N_{buf4} of the most recently obtained pressure samples (step S35).

For each sensing electrode 5, 6, a linear regression line is calculated for the corresponding pressure samples stored in the regression buffer (step S36). The regression line is calculated conditionally upon the regression buffer having been filled. For example, for the n^{th} of N first sensing electrodes 5, once the regression buffer has N_{buf4} prior samples stored, the pressure signal processing module 15 calculates a regression line for the n^{th} of N first sensing electrodes 5 using set of pressure samples {P(t,yₙ), P(t−1,yₙ), . . . , P(t−N_{buf4}+1,yₙ)}.

The condition that the regression buffer be filled may be enforced in a number of ways. For example, a counter of the number of samples since the last user interaction 27 (FIG. 13) was detected from the capacitance information 20 may be used. Alternatively, the regression buffer may be initially populated with undefined, e.g. “Inf” or “NAN” (not-a-number) values, so that until all of the initial values have been overwritten with real data, the regression analysis will not return numeric values, allowing simple detection of when the regression buffer has been filled. In this case, the regression buffer may be reset to this initial state (step S41) when a user interaction 27 (FIG. 13) occurs.

For each sensing electrode 5, 6, the gradient, m, and variance, VAR, obtained from regression line analysis of the corresponding pressure samples are compared to a predetermined gradient threshold m_{recal} and a predetermined variance threshold VAR_{recal} for recalibration (step S37).

If the gradient m and variance VAR corresponding to a particular sensing electrode 5, 6 are both less than the respective gradient and variance thresholds m_{recal}, VAR_{recal} (step S37), the corresponding DC₂ offset value is updated (step S38). For example, if for the n^{th} of N first sensing electrodes 5 the conditions m<m_{recal} and VAR<VAR_{recal} are satisfied, the corresponding DC₂ offset, DC₂(yₙ) is updated to, for example P(t,yₙ), or MEAN({P(t,yₙ), P(t−1,yₙ), . . . , P(t−N_{buf4}+1,yₙ)}), and so forth for each other sensing electrode 5, 6.

Unlike the initial calibration (step S17), the DC₂ offsets need not all be updated at the same time. For example, if the regression lines corresponding to some sensing electrodes 5, 6 satisfy the gradient and variance thresholds, then the corresponding DC₂ offsets will be updated, and the remaining DC₂ offsets will not be updated.

The pressure samples {P(t,y₁), P(t,y₂), . . . , P(t,y_{N})}, {P(t,x₁), P(t,x₂), . . . , P(t,x_{M})} are each adjusted by subtracting the respective DC₂ offset values {DC₂(y₁), DC₂(y₂), . . . , DC₂(y_{N})}, {DC₂(x₁), DC₂(x₂), . . . , DC₂(x_{M})} (step S39). If any of the DC₂ offsets were not updated (step S38), then the previous DC₂ offsets are used. All of the DC₂ offsets are initialised to zero when the touch panel 1 and system 13 are powered up.

The terminology of, for example, P(t,yₙ) is also used to refer to the pressure samples following adjustment for DC₂ offset.

If active user interactions 27 (FIG. 13) are determined from the capacitance information 20 (step S33), it is checked whether the touch flag has a value of “true” (step S40).

If the touch flag has a value of “true” (step S40), the regression buffer is cleaned (step S41). The regression buffer may be reset to all zeros, for example when a counter is used to determine when the regression buffer is full. Alternatively, as described hereinbefore, the regression buffer may cleaned by resetting all the stored values to “Inf” or “NAN” undefined values. Most computer programming or scripting languages include support for an undefined value, in order to permit support for divide by zero errors and so forth.

The touch flag is set to a value of “false” (step S42), and the pressure samples {P(t,y₁), P(t,y₂), . . . , P(t,y_{N})}, {P(t,x₁, P(t,x₂), . . . , P(t,x_{M})} are each adjusted by subtracting the respective DC₂ offset values {DC₂(y₁), DC₂(y₂), . . . , DC₂(y_{N})}, {DC₂(x₁), DC₂(x₂), . . . , DC₂(x_{M})} (step S39).

The overall effect of steps S33, S34, S40 and S42 is that the touch flag will take a value of “true” when there are no user interactions, and that once the first sample of a new user interaction is received, the touch flag is reset to a value of “false” and the regression buffer is cleaned.

The continuous re-calibration of the DC₂ offsets during quiet periods of the touch panel 1 when there are no user interactions 27 (FIG. 13) maintains the accuracy of the method against drifts in the DC offset over time.

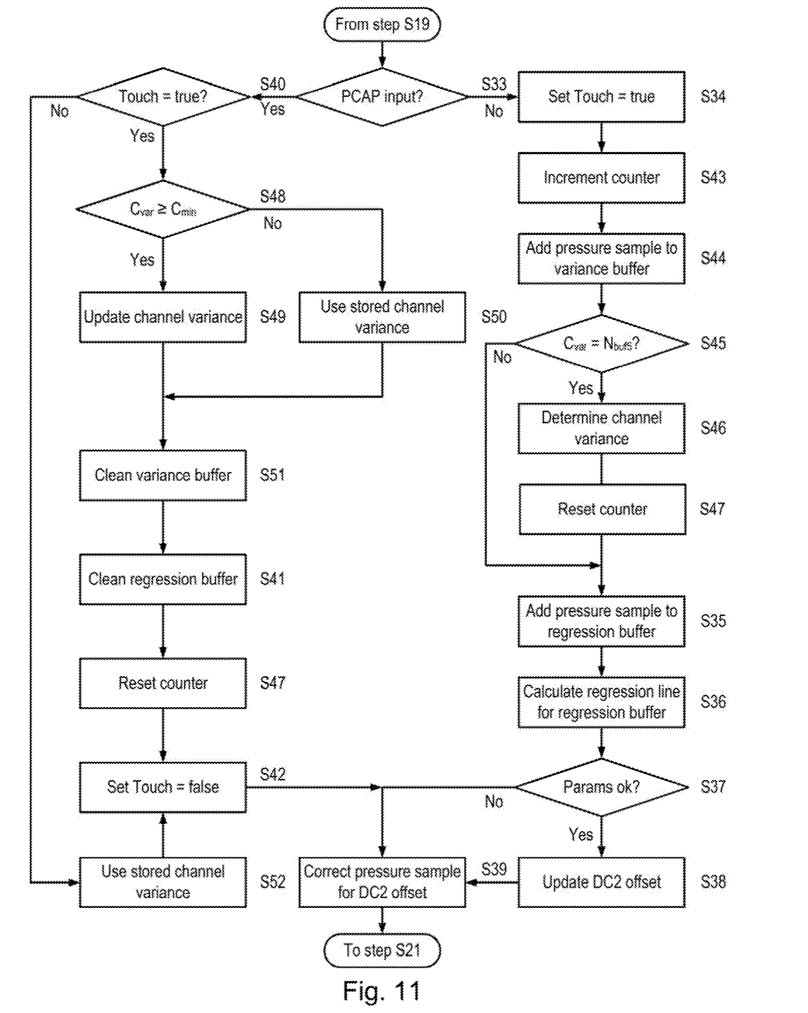

Second re-calibration process: Referring also to FIG. 11, a process-flow diagram of a second example re-calibration process (step S20) is shown.

The second example re-calibration process (step S20) includes all the steps of the first example re-calibration process (step S20), and additional steps which are directed to tracking the variance of signals corresponding to each sensing electrode 5, 6. This information may be useful for estimating the quality of measurements corresponding to each sensing electrode 5, 6, which is used in some examples of the method to assist in assigning decision making channels. Steps of the second re-calibration method which are the same as the first re-calibration method have the same numbering.

The presence of any active user interactions 27 (FIG. 13) is determined using the capacitance information (step S33) and, if there are no user interactions 27 (FIG. 13), the touch flag is set to a value of “true” (step S34) as described hereinbefore.

A counter, Cᵥₐᵣ is incremented by one (step S43). The counter Cᵥₐᵣ is reset to zero whenever a user interaction 27 (FIG. 13) is first detected (step S47).

The pressure signal processing module 15 adds the sets of pressure samples {P(t,y₁), P(t,y₂), . . . , P(t,y_{N})}, {P(t,x₁), P(t,x₂), . . . , P(t,x_{M})} to a variance buffer which stores up to a number, N_{buf5} of the most recently obtained pressure samples (step S44).

The pressure signal processing module 15 checks whether the counter, Cᵥₐᵣ, is equal to the variance buffer length N_{buf5} (step S45). If it is, a temporary channel variance, VARₜₑₘₚ is calculated based on the filled variance buffer (step S46). For example, for the n^{th} of N first sensing electrodes 5, the pressure signal processing module 15 measures the variance of the set of pressure samples {P(t,yₙ), P(t−1,yₙ), . . . , P(t−N_{buf5}+1,yₙ)}. In general, the channel variance corresponding to each sensing electrode 5, 6 is tracked individually, so that the measured variances form sets {VARₜₑₘₚ(y₁), VARₜₑₘₚ(y₂), . . . , VARₜₑₘₚ(y_{N})}, {VARₜₑₘₚ(x₁), VARₜₑₘₚ(x₂), . . . , VARₜₑₘₚ(x_{M})}.

The counter Cᵥₐᵣ is then reset to zero (step S47). In this way, the temporary channel variance, VARₜₑₘₚ is updated every N_{buf5} samples to track the variance corresponding to each sensing electrode 5, 6.

The DC₂ offset checking and updating procedure proceeds as described hereinbefore (steps S35, S36, S37 and S38).

If a user interaction 27 (FIG. 13) is detected in the capacitance information 20 (step S33), then the pressure signal processing module 15 checks whether the touch flag is set to a value of “true”, as described hereinbefore (step S40).

If the touch flag is equal to “true” (step S40), i.e. if this is the first sample corresponding to a new user interaction 27 (FIG. 13), the pressure signal processing module 15 determines whether the counter Cᵥₐᵣ is equal to or exceeds a minimum value Cₘᵢₙ (step S48). If the counter satisfies Cᵥₐᵣ<Cₘᵢₙ, then the set of most recently obtained channel variances {VARₜₑₘₚ(y₁), VARₜₑₘₚ(y₂), . . . , VARₜₑₘₚ(y_{N})}, {VARₜₑₘₚ(x₁), VARₜₑₘₚ(x₂), . . . , VARₜₑₘₚ(x_{M})} are set as output variances {VARₒᵤₜ(y₁), VARₒᵤₜ (y₂), . . . , VARₒᵤₜ(y_{N})}, {VARₒᵤₜ(x₁), VARₒᵤₜ(x₂), . . . , VARₒᵤₜ(x₁)} corresponding to the newly begun user interaction 27 (FIG. 13) (step S50). In this way, if the gap between a first and a second user interaction 27 (FIG. 13) is less than Cₘᵢₙ, the most recently obtained channel variance, prior to the first user interaction 27 (FIG. 13), is also assigned to the second user interaction 27 (FIG. 13).

However, if the counter Cᵥₐᵣ≥Cₘᵢₙ (step S48), then the output variances {VARₒᵤₜ(y₁), VARₒᵤₜ(y₂), . . . , VARₒᵤₜ(y_{N})}, {VARₒᵤₜ(x₁), VARₒᵤₜ(x₂), . . . , VARₒᵤₜ(x_{M})} corresponding to each sensing electrode 5, 6 are determined as the weighted average of the most recently obtained channel variances {VARₜₑₘₚ(y₁), VARₜₑₘₚ(y₂), . . . , VARₜₑₘₚ(y_{N})}, {VARₜₑₘₚ(x₁), VARₜₑₘₚ(x₂), . . . , VARₜₑₘₚ(x_{M})} and the variances of the currently filled portion of the variance buffer (step S49). For example, for the n^{th} of N first sensing electrodes 5, the pressure signal processing module 15 obtains the corresponding output variance VARₒᵤₜ(yₙ) as a weighted sum of VARₜₑₘₚ(yₙ) and the variance of the set of pressure samples {P(t,yₙ), P(t−1,yₙ), . . . , P(t−Cᵥₐᵣ+1,yₙ)}, and so forth for each other sensing electrode 5, 6. The sum is weighted according to the number of samples used to obtain the variance values, i.e. N_{buf5} and Cᵥₐᵣ. In this way, the most accurate and temporal measurement of variance leading up to a new user interaction 27 (FIG. 13) may be obtained.

The output variance values {VARₒᵤₜ(y₁), VARₒᵤₜ(y₂), . . . , VARₒᵤₜ(y_{N})}, {VARₒᵤₜ(x₁), VARₒᵤₜ(x₂), . . . , VARₒᵤₜ (x_{M})} corresponding to each sensing electrode 5, 6 may, in some examples, contribute to a quality metric of the respective sensing electrodes 5, 6. Such quality metrics may be used to help determine the key, or decision making, sensing electrodes 5, 6 for measuring sets of output forces {F(t,y₁), F(t,y₂), . . . , F(t,y_{N})}, {F(t,x₁), F(t,x₂), . . . , F(t,x_{N})}. The functions of assigning and using key, or decision making, sensing electrodes 5, 6 are described hereinafter.

For the first sample of a new user interaction 27 (FIG. 13), the variance buffer is cleaned by re-initialising all values to zero (step S51), the regression buffer is cleaned as described hereinbefore (step S41), the counter Cᵥₐᵣ is reset to zero (step S47), and the touch flag is set to a value of “false” as described hereinbefore (step S42)

When a user interaction 27 (FIG. 13) is detected from the capacitance information 20 (step S33) and the touch flag has a value of “false” (step S40), i.e. for the second and subsequent samplings of a user interaction, the most recent values of output variances {VARₒᵤₜ(y₁), VARₒᵤₜ(y₂), . . . , VARₒᵤₜ(y_{N})}, {VARₒᵤₜ(x₁), VARₒᵤₜ(x₂), . . . , VARₒᵤₜ(x_{M})} are re-used (step S52). In other words, the output variances VARₒᵤₜ determined when a user interaction begins are used throughout the entire user interaction 27 (FIG. 13). This is because the underlying variance corresponding to each sensing electrode 5, 6 may be difficult to determine during a user interaction 27 (FIG. 13) on account of pressure signals and/or additional noise sources associated with the user interaction 27 (FIG. 13).

Push elaboration process: Referring also to FIG. 12, a process-flow diagram of the process of determining the state register values S₀, S₁, S₂, S₃, the processed pressure values {P*(t,y₁), P*(t,y₂), . . . , P*(t,y_{N})}, {P*(t,x₁), P*(t,x₂), . . . , P*(t,x_{M})}, and optionally the type (hard or soft) of ongoing user interactions 27 (FIG. 13) is shown. This process is referred to as a “push elaboration” process in the interests of brevity.

Following determination of the number of active user interactions (step S21), the push elaboration process commences (step S22).

The active sensor set is assigned to the first sensor set (step S53). In general, a touch panel 1 may include one, two or more distinct sets of sensing electrodes 5, 6. For example, in the touch panel 1 shown in FIGS. 1 and 2, the first sensing electrodes 5 form a y-set which measures forces in the y-direction and the second sensing electrodes 6 form an x-set which measures forces in the x-direction.

The physical parameters of the active sensor set are retrieved (step S54). For example, in the touch panel 1 shown in FIGS. 1 and 2 having a first, y-set of sensing electrodes 5 and a second, x-set of sensing electrodes 6, the spacing of the first electrodes 5 in the y-direction does not need to be equal to the spacing of the second electrodes 6 in the x-direction. The physical positions and spacing of the sensing electrodes 5, 6 are used to determine key or decision making electrodes 5, 6 (step S58).

The current set of pressure samples {P(t,y₁), P(t,y₂), . . . , P(t,y_{N})}, {P(t,x₁), P(t,x₂), . . . , P(t,x_{M})} are added to a push elaboration pressure buffer holding a number N_{buf6} of the most recently received pressure samples (step S55). For example, for the n^{th} of N first sensing electrodes 5, the push elaboration pressure buffer holds the set of pressure samples {P(t,yₙ), P(t−1,yₙ), . . . , P(t−N_{buf6}+1,yₙ)}, and so forth for each other sensing electrode 5, 6.

The pressure signal processing module 15 determines whether any user interactions 27 (FIG. 13) are occurring, based on the capacitance information 20 (step S56). Provided that at least one user interaction 27 (FIG. 13) is occurring, a user interaction duration counter Cᵢₙₜ is incremented (step S57). The counter Cᵢₙₜ is incremented by unity.

An initial assignment of the key, or decision making, sensing electrodes 5′, 6′ is made based on the capacitance information 20 (step S58). In general, for each set of sensing electrodes 5, 6, the initial assignment of the decision making sensing electrodes 5′, 6′ comprises projecting the 2-D multi-touch data for one or more user interactions 27 (FIG. 13) from the capacitance information 20 onto the physical locations of the respective set of electrodes, to determine the closest sensing electrodes 5, 6 to each active user interaction 27 (FIG. 13). The closest sensing electrodes 5, 6 are more likely to have the strongest pressure signal, and consequently are initially selected as the decision making sensing electrode 5′, 6′. However, the initial assignment may be subsequently altered if, for example, an adjacent channel is determined to have a superior quality. For example, the closest sensing electrode 5, 6 to a user interaction 27 (FIG. 13) may have the strongest pressure signal, and also suffer the most from electrostatic discharge of the user's digit, so that an adjacent sensing electrode 5, 6 actually provides a better quality signal. When the sensing electrodes 5, 6 are arranged as x and y electrodes, as shown in FIGS. 1 and 2, the projection of the 2-D locations of user interactions onto the x-set or the y-set may result in a number of decision making electrode 5′, 6′ that is less than the number of active user interactions 27 (FIG. 13).

Referring also to FIGS. 13 and 14, a process of making the initial assignment of the decision making sensing electrodes 5′, 6′ is illustrated for an example of four concurrent user interactions 27_{A}, 27_{B}, 27_{C}, 27_{D}.

In the example shown in FIGS. 13 and 14, there are N=8 first sensing electrodes 5₁, 5₂, . . . , 5₈, spaced such that the locus of points closest to the n^{th} first sensing electrode 5ₙ may be expressed as yₙ₋₁≤y<yₙ, and corresponds to pressure sample P(t,yₙ). Similarly, there are M=15 second sensing electrodes 6₁, 6₂, . . . , 6₁₅, spaced such that the locus of points closest to the m^{th} second sensing electrode 6ₘ may be expressed as xₘ₋₁≤x<xₘ, and corresponds to pressure sample P(t,xₘ).

Referring in particular to FIG. 13, a first user interaction 27_{A} has centroid coordinates x=x_{A}, y=y_{A}, determined by the capacitive signal processing module 16 and included in the capacitance information 20. The centroid coordinates x_{A}, y_{A} are such that x₁≤x_{A}<x₂ and y₂≤y_{A}<y₃, i.e. the first user interaction 27_{A} is closest to the 3^{rd} y electrode 5₃ and the 2^{nd} x electrode 6₂. Similarly, a second user interaction 27_{B} has centroid coordinates x₅≤x_{B}<x₆ and y₅≤y_{B}<y₆, a third user interaction 27_{C} has centroid coordinates x₅≤x_{C}<x₆ and y₂≤y_{C}<y₃, and a fourth user interaction 27_{C} has centroid coordinates x₁₁≤x_{D}<x₁₂ and y₃≤y_{D}<y₄.

Referring in particular to FIG. 14, when the centroid coordinates of the four user interactions 27_{A}, 27_{B}, 27_{C}, 27_{D} are projected onto the x-axis, the second and third user interactions 27_{B}, 27_{C} are not-unique. Both the second and the third user interactions 27_{B}, 27_{C} correspond to the 6^{th} or x electrode 6₆. Consequently, since decision making sensing electrodes 5′, 6′ should be unique, three of the x electrodes 6 are selected to be decision making electrodes 6′, namely the 2^{nd} x electrode 6₂ corresponding to the first user interaction 27_{A}, the 6^{th} x electrode 6₆ corresponding to the second and third user interactions 27_{B}, 27_{C}, and the 12^{th} x electrode 6₁₂ corresponding to the fourth user interaction 27_{D}.

Similarly, when the set of first, or y sensing electrodes 5₁, 5₁, . . . , 5₈ are processed, three decision making y electrode 5′ are selected, namely the 3^{rd} y electrode 5₃ corresponding to the first and third user interactions 27_{A}, 27_{C}, the 4^{th} y electrode 5₄ corresponding to the fourth user interaction 27_{D}, and the 6^{th} y electrode 5₆ corresponding to the second user interaction 27_{B}.

The pressure signal processing module 15 determines, based on the capacitance information 20, whether the status or pattern of the one or more user interactions 27 has altered since the previous sampling (step S59). The methods of the present specification process the samples corresponding to the decision making electrodes 5′, 6′ first, and the remaining, non-decision making electrodes 5, 6 are each assigned to depend on one or the decision making electrode 5′, 6′. The status of the one or more user interactions 27 is determined to have been altered when the number or identity of decision making electrodes 5′, 6′ changes, for example, when a new user interaction 27 begins when a user contacts an additional digit to the touch panel 1. Alternatively, the status of the one or more user interactions 27 is altered when the number of user interactions decreases when a user removes a digit from the touch panel 1. Alternatively, the status of the one or more user interactions 27 is altered when one or more user interactions 27 has moved far enough that the corresponding centroid corresponds to a different sensing electrode 5, 6, and so forth.

When the status of the one or more user interactions 27 is determined to have been altered (step S59), the sensing electrode 5, 6 dependencies are allocated or re-allocated (depending on whether any user interactions 27 were in progress for the previous sample) (step S60). The non-decision making electrodes 5, 6 are each assigned to a decision making electrode 5′, 6′ based on proximity.

Referring also to FIG. 15, one example of assigning electrode 5, 6 dependencies is shown.

The example shown in FIG. 15 corresponds to the four user interactions 27_{A}, 27_{B}, 27_{C}, 27_{D} shown in FIGS. 13 and 14. In a first iteration, It1, the decision making electrode 6′ are assigned as 62 corresponding to x₁≤x<x₂, as 6₆ corresponding to x₅≤x<x₆, and as 6₁₂ corresponding to x₁₁≤x<x₁₂.

In a second iteration, It2, the electrodes 6₁, 6₃, 6₅, 6₇, 6₁₁, 6₁₃ immediately adjacent to the decision making electrodes 6₂, 6₆, 6₁₂ are assigned to depend from the adjacent decision making electrodes 6₂, 6₆, 6₁₂. For example, the electrode 6₅ corresponding to x₄≤x<x₅ and the electrode 6₇ corresponding to x₆≤x<x₇ are both assigned to depend from the decision making electrode 6₆ corresponding to x₅≤x<x₆.

Further iterations It3, It4, are carried out, and during each, unassigned electrodes 6 are assigned to depend from the same decision making channel 6′ as their immediate neighbours, until all electrodes 6 have been assigned. Conflict may be resolved using any suitable rule such as, for example, assigning to the decision making electrode 6′ which is numbered lower (as shown in FIG. 15), or numbered higher, or by always assigning to the left or to the right in the event of conflict. The dependencies of the non-decision making first electrodes 5 are assigned in the same way.

Alternatively, an iterative process need not be used. Instead, all non-decision making electrodes 5, 6 may be assigned to depend from the most proximate decision making electrode 5′, 6′ in a single step, with conflicts resolved as described hereinbefore.

However the electrode dependencies are determined, an alternative for resolving conflicts is to use the precise centroid coordinates from the capacitance information 20 to determine which user interaction 27 is closest to an electrode 5, 6, then assign that electrode 5, 6 to depend from the corresponding decision making electrode 5′, 6′. The centroid coordinates may be more precise than the spacing of electrodes 5, 6, because of the standard position interpolation functions applied during conventional projected capacitive touch sensing.

The electrode processing order is allocated or reallocated (step S61). The decision making electrodes 5′, 6′ are processed first, followed by the non-decision making electrodes 5, 6 grouped according to which decision making electrode 5′, 6′ they depend from/are associated with.

For example, for the set of user interactions 27_{A}, 27_{B}, 27_{C}, 27_{D} shown in FIGS. 13 to 15, the second electrodes 6 would be processed in the order 6₂, 6₆, 6₁₂, corresponding to the decision making electrodes 6′, followed by 6₁, 6₃, 6₄ corresponding to the first decision making electrode 6₂, followed by 6₅, 6₇, 6₈,6₉ corresponding to the second decision making electrode 66, followed by 6₁₀, 6₁₁, 6₁₃, 6₁₄, 6₁₅ corresponding to the third decision making electrode 6₁₂.

If the state of the one or more user interactions is unchanged (step S59) or following (re-)ordering of the electrode processing order (step S61), the first electrode 5, 6 in the previous or new ordering is selected (step S62), and the respective pressure sample P(t) is processed to determine a corresponding state register value S₀, S₁, S₂, S₃ and processed pressure sample P*(t) (step S63). For example, when the n^{th} of N first sensing electrodes is processed, the respective pressure sample P(t, yₙ) is processed to determine a corresponding state register value S₀, S₁, S₂, S₃ and a corresponding processed pressure sample P*(t, yₙ).

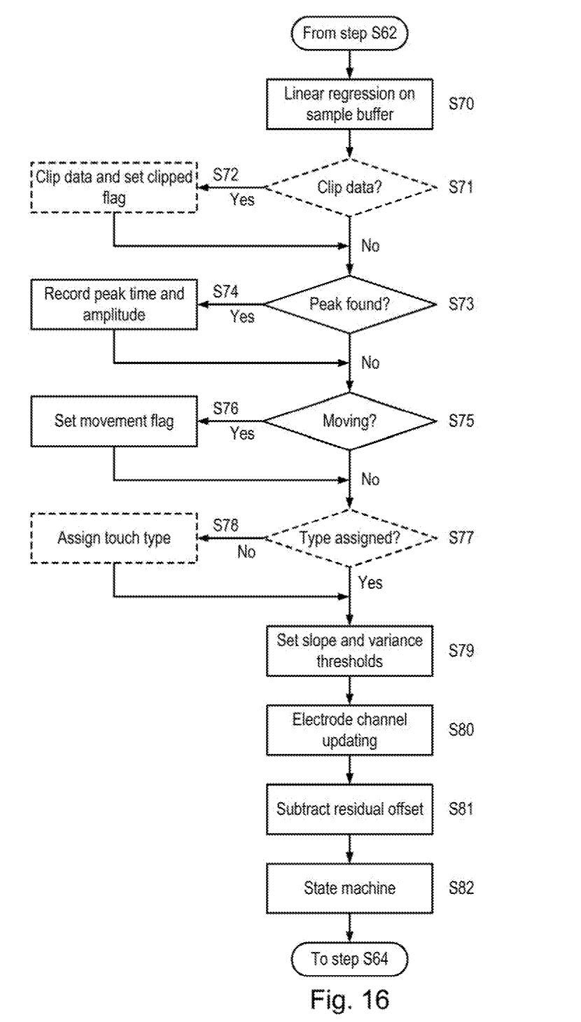

The processing of electrodes (step S63) is not limited to only the determination of the state register value S₀, S₁, S₂, S₃, and a number of optimisations may also be implemented during this step, including, for example, assignment of a touch type such as a “hard” or “soft” type. These optional processes are described in more detail with reference to FIGS. 16 to 23. However, only the determination of states S₀, S₁, S₂, S₃ and processed pressure samples {P*(t,y₁), P*(t,y₂), . . . , P*(t,y_{N})}, {P*(t,x₁), P*(t,x₂), . . . , P*(t,x_{M})} are essential to the method of the present specification.

If there are further electrodes 5, 6 within the currently processed set (step S64), the next electrode in the current ordering is selected (step S65) and processed (step S63).

If there are no further electrodes 5, 6 within the currently processed set (step S64), it is checked whether there are additional sensor sets to process (step S66), and if there are not the method moves on to update the sets of output force values {F(t,y₁), F(t, y₂), . . . , F(t,y_{N})}, {F(t,x₁), F(t, x₂), . . . , F(t,x_{M})} (step S23).

If there are additional sensor sets to process (step S66), the next sensor set is selected (step S67), the parameters for the next sensor set are retrieved (step S54) and the push elaboration process (step S22) is repeated for the new sensor set.

When there are no user interactions 27 occurring, as determined from the capacitance information 20 (step S56), all buffers and output force values {F(t,y₁), F(t, y₂), . . . , F(t,y_{N})}, {F(t,x₁), F(t, x₂), . . . , F(t,x_{M})} are reset, for example to zero (step S68), and the counter Cᵢₙₜ is reset to zero (step S69).

Electrode processing: Referring also to FIG. 16, a process-flow diagram of an example of the electrode processing (step S63) is shown. For the purposes of clear exposition, the process is described in relation to processing the n^{th} of N first sensing electrodes 5, but is equally applicable to any of the sensing electrodes 5, 6.

A linear regression analysis is performed on the data for the currently processed electrode 5, 6 stored in the push elaboration pressure buffer (step S70). The slope, m, variance, VAR and mean value of the corresponding set of pressure samples {P(t,yₙ), P(t−1,yₙ), . . . , P(t−N_{buf6}+1,yₙ)} are measured.

An optional data clipping process may be performed (steps S71, S72). The data clipping process may be useful when a touch panel 1 and system 13 experience electrostatic discharge from a user's digit, which can cause excessively large positive or negative values of a pressure sample P(t,yₙ). The pressure sample P(t, yₙ) is checked against a clipping threshold P_{clip} (step S71), and if the magnitude of the pressure sample |P(t,yn)| exceeds the clipping threshold P_{clip}, the pressure sample P(t, yₙ) is set to equal the clipping threshold (step S72), according to:

$$P ( t , {y}_{n} ) \to \{ \begin{matrix}- {P}_{clip} & if & P ( t , {y}_{n} ) < - {P}_{clip} \\ {P}_{clip} & if & P ( t , {y}_{n} ) > {P}_{clip} \\ P ( t , {y}_{n )} & if & \vert P ( t , {y}_{n} ) \vert \leq \vert {P}_{clip} \vert\end{matrix} \}$$

Additional, a data clipping flag is set to a value “clipped” for the electrode being processed (step S72). If the data clipping flag is equal to a value “clipped”, then the process of updating the residual offset corresponding to the electrode (step S80) is omitted, to avoid false detection of a flat region if an electrodes data is being clipped. The data clipping flag may also be used to indicate that output force values F(t,yₙ) corresponding to the processed electrode may have low reliability. The clipping threshold P_{clip} may be pre-calibrated, for example, by applying a known, upper bound calibration force to the touch panel 1 to determine a maximum probable pressure sample value P(t,yₙ). In general, the pressure signals 18 from across the touch panel 1 may vary as a function of position, because of plate bending of the touch panel 1 combined with the mechanical boundary conditions at the touch panel 1 boundary. Consequently, the clipping threshold Pup may be pre-calibrated separately for each sensing electrode 5, 6, to obtain sets of clipping thresholds {P_{clip}(y₁), P_{clip}(y₂), . . . , P_{clip}(y_{N})}, {P_{clip}(x₁), P_{clip}(x₂), . . . , P_{clip}(x_{M})}.

The current pressure sample P(t,yₙ) is checked to consider whether the initial loading peak P₁ may be assigned (step S73). When a new user interaction 27 begins, a temporary peak value Pₜₑₘₚ₁ is set to zero. Each subsequently received pressure sample P(t,yₙ) is compared against the temporary peak value Pₜₑₘₚ₁. If the current sample P(t,yₙ) exceeds the temporary peak value Pₜₑₘₚ₁, then the temporary peak value is updated as Pₜₑₘₚ₁=P(t,yₙ). For example, if increasing applied force corresponds to negative values, then the temporary peak value Pₜₑₘₚ₁ is updated according to:

$${P}_{temp 1} \to \{ \begin{matrix}P ( t , {y}_{n} ) & if & P ( t , {y}_{n} ) < {P}_{temp 1} \\ {P}_{temp 1} & & otherwise\end{matrix} \}$$

Whenever the temporary peak value Pₜₑₘₚₜ₁ is updated, a peak counter Cₚₑₐₖ is set to a positive integer value N_{detect} and a peak time tₚₑₐₖ is set to the time elapsed since the start of the user interaction 27, as determined from the capacitance information 20. A separate temporary peak value Pₜₑₘₚ₁, a peak counter Cₚₑₐₖ, and peak time tₚₑₐₖ are stored and tracked for each separate user interaction 27 detected by the capacitive signal processing module 16 and included in the capacitance information 20, and optionally for each sensing electrode 5, 6.

The peak counter Cₚₑₐₖ is initialised to a value of negative one when a news user interaction 27 commences, and is decremented by one each time that a new pressure sample P(t,yₙ) is received. Thus, the peak counter Cₚₑₐₖ is only positive for a period of N_{detect} samples after updating the temporary peak value Pₜₑₘₚ₁Once the peak counter Cₚₑₐₖ has counted down and is equal to Cₚₑₐₖ=0, the initial peak P₁ is confirmed by setting the temporary peak value Pₜₑₘₚ₁ and the corresponding peak time tₚₑₐₖ to correspond to the initial loading peak P₁ amplitude and time respectively (step S74).

To avoid a failure to reach a determination of the initial loading peak P₁ when the pressure is increasing relatively slowly, if the temporary peak value Pₜₑₘₚ₁ is updated when the peak counter Cₚₑₐₖ satisfies the conditions 0<Cₚₑₐₖ≤N_{detect}/2, then the peak counter is set to Cₚₑₐₖ=1, so that a decision on the initial peak P₁ location is forced on the next sample when Cₚₑₐₖ is decremented to zero. This condition corresponds to detecting another peak very shortly, but not immediately, after the first peak. Consequently, the value N_{detect} should be set such that half the countdown period is longer, preferably by several periods, than a typical fluctuation period of the underlying noise, so that the condition to force a decision on the initial peak P₁ location is not triggered except by fluctuations in the pressure signal 24. The fluctuation period of the underlying noise may be determined, for example, by obtaining a frequency spectrum of the pressure signal 24 in the absence of any user interactions.

Preferably, because the decision making electrodes 5′,6′ are processed first, when the non-decision making electrodes 5, 6 are processed, the step of determining whether a peak is found (step S73) may consist of checking whether the decision making electrode 5′, 6′ has found the initial loading peak P₁, i.e. if the peak found flag of the decision making electrode 5, 6 has value “true”, then setting the time and amplitude for the non-decision making electrode being processed correspondingly (step S74). For example, for the example user interactions 27 shown in FIGS. 13 to 15, once the peak P₁ is found for the decision making electrode 6₂, the time index tₚₑₐₖ is set and the amplitude is P(tₚₑₐₖ,y₂). Then, for the non-decision making electrodes 6₁, 6₃, 6₄, the peak amplitude may be simply assigned based on the respective pressure samples at the peak time tₚₑₐₖ, i.e. the respective amplitudes may be set as P(tₚₑₐₖ,y₁), P(tₚₑₐₖ,y₃), P(tₚₑₐₖ,y₄). In this way, substantial processing of the non-decision making electrodes 5, 6 may be skipped, increasing the speed of the push elaboration process (step S22) and thus reducing the latency in updating the measured output force values F(t). Accuracy may be preserved because the one or more decision making electrodes 5′, 6′ are likely to have the relatively strongest signals for the corresponding one or more user interactions 27.

In an optional extension of the method, each sensing electrode 5, 6 may be assigned a quality metric based on, for example, the variance corresponding to that sensing electrode 5, 6 prior to the corresponding user interaction 27 (see FIG. 11), and/or a ratio of the present pressure sample P(t,yₙ) to that of the corresponding decision making electrode 5′, 6′. For example, if the n^{th} of N first sensing electrodes 5 is being processed and the corresponding decision making electrode 5′ is the p^{th} of N first sensing electrodes 5, then the ratio P(t,yₙ)/P(t,yₚ) may be used as a quality metric. Of course, quality metrics are not limited to these examples, and other statistical measures of sensing electrode 5, 6 signal quality may be used. If the quality metric of a non-decision making electrode 5, 6 is less than a pre-calibrated threshold, then the non-decision making electrode 5, 6 may take the initial loading peak P₁ detection from the corresponding decision making electrode 5′, 6′. However, if the quality metric of a non-decision making electrode 5, 6 exceeds the pre-calibrated threshold, then the non-decision making electrode 5, 6 may make an independent detection of the initial loading peak P₁. This may be advantageous when the non-decision making electrode 5, 6 detects the peak P₁ before the decision making electrode 5′, 6′, as this may indicate that the decision making electrode 5′, 6′ does not actually have the best signal, and the non-decision making electrode 5, 6 which detected the peak P₁ may be updated to be the decision making electrode 5′, 6′ for the corresponding user interaction 27.

Based on the capacitance information 20, the centroid coordinates of a user interaction 27 corresponding to the sensing electrode 5, 6 being processed are checked against prior values to determine differences Δx, Δy, and the user interaction is determined to be moving if the differences satisfy (step S75):

\sqrt{Δx²+Δy²}>Δₘₒᵥₑ

In which Δₘₒᵥₑ is a pre-calibrated movement threshold. The movement threshold Δₘₒᵥₑ may be determined by, for example, experiments in which the centroid coordinates of a user's digit is held in the same place, allowing the noise in the centroid coordinates to be quantified. The movement threshold Δₘₒᵥₑ may then be set as five times the standard error of the measured centroid coordinates with respect to mean centroid coordinates throughout the calibration experiment. Preferably, the movement threshold Δₘₒᵥₑ may also take into account variations in the contact area of a user's digit as the applied pressure is increased or decreased, which may cause offset in the centroid coordinates. Again, this effect may be accounted for by conducting suitable calibration experiments.

If the user interaction 27 corresponding to the electrode being processed is determined to be moving (step S75), a moving flag is set to a value of “true” (step S76).

Preferably, because the decision making electrodes 5′, 6′ are processed first, the assignment of the moving flag for non-decision making electrodes 5, 6 (steps S75, S76) may be simplified by assigning the moving flag status of each non-decision making electrode 5, 6 according to the value of the corresponding decision making electrode 5′, 6′.

Optionally, a type may be assigned to the user interaction 27 corresponding to the sensing electrode 5, 6 being processed (steps S77, S78). The measured pressure signal 24 shown in FIGS. 5 and 6 is of a first or “hard” type, and corresponds to a user placing a digit or conductive stylus relatively quickly, so that there is an initial impact. However, when a user places a digit or conductive stylus on the touch panel 1 gently before slowly increasing the applied force, it may be advantageous to modify the progression through the state register values S₀, S₁, S₂, S₃. This second type of user interaction is referred to as a second, or “soft” type herein.

Referring also FIG. 17, measured pressure signal 24 values P(t) and corresponding processed pressure signal 25 value P*(t) corresponding to a “soft” type user interaction are shown, along with the transitions between the state register values S₀, S₁, S₂, S₃. As discussed hereinafter, the third, or settling state S₂ may be omitted when processing “soft” type user interactions 27.

Referring also to FIG. 18, the output force 26 values F(t) corresponding to the soft type touch of FIG. 17 are shown.

In may be observed that following the start of the user interaction 27 at an initial offset P₀, as determined using the capacitance information 20, the pressure signal 24 values P(t) increase above zero to a false peak P₅ which it is believed may originate from electrostatic discharge of the user's digit. During the false peak P₅, as the state register value is set to the initial state S₀, the processed pressure signal P*(t) does not increase above zero during the false peak P₅.

However, for a “soft” type user interaction, the initial loading peak P₁ may occur relatively later than for a “hard” type user interaction. Furthermore, the pressure signal 24 values P(t) may not immediately decay to the prevailing DC offset P_{off}. Instead, charge generation from increased straining of the piezoelectric material layer 9 may be approximately in balance with the decay of the pressure signal 24 values P(t), without reaching or crossing zero. For example, as shown in FIG. 17, there may not be a well defined initial loading peak P₁ in the measured pressure signal 24.

When “hard” and “soft” type user interactions are implemented, the pressure signal processing module 15 checks, whether a type has already been assigned to the user interaction corresponding to the electrode 5, 6 being processed (step S77), and if a type has not yet been assigned, a type assignment process is performed (step S78). The type assignment process may have three possible outcomes, “hard”, “soft” or “undefined”, the latter being applied when the conditions for making an assignment to “hard” or “soft” are not yet met. A type assignment is not made until the initial peak P₁ is assigned, when the peak counter Cₚₑₐₖ equals zero. At this point, if the peak time tₚₑₐₖ since the beginning of the user interaction (determined from capacitance information 20) exceeds a maximum delay Δtₘₐₓ, so that tₚₑₐₖ>Δtₘₐₓ, the user interaction is set as a “soft” type. Otherwise, the user interaction is set as a “hard” type. When a user interaction is set as a “soft” type user interaction, the third state S₂ may be skipped, as explained hereinafter.

The maximum delay Δtₘₐₓ may vary depending on the particular touch panel 1 and system 13, and may be pre-calibrated by performing suitable experiments using applied force profiles having controlled, known ramping rates. The calibration data may be processed separately as a “hard” type and as a “soft” type user interaction, and below a critical ramping rate, the “soft” type processing may provide a closer reconstruction of the applied calibration force profile. The maximum delay Δtₘₐₓ may then be adjusted until the type assignment process (step S78) assigns the calibration force profiles at or below the critical ramping rate as “soft” type. Other methods of setting a suitable maximum delay Δtₘₐₓ could be used by a skilled person.

A “soft” type user interaction may be detected in two broad circumstances. The first is a clean detection of an initial loading peak P₁ which occurs after the maximum delay Δtₘₐₓ. The second, which is illustrate in FIGS. 17 and 18, is when a gradually increasing applied force leads to fluctuations in the measured pressure signal 24 which cause the temporary peak value Pₜₑₘₚ₁ to be updated when the peak counter Cₚₑₐₖ satisfies the conditions 0<Cₚₑₐₖ≤N_{detect}/2, so that the peak counter is set to Cₚₑₐₖ=1 and a decision on the initial peak P₁ location and user interaction type is forced on the next sample.

A slope threshold meat and a variance threshold VAR_{flat} are set for the electrode being processed (step S79). The values of slope and variance thresholds meat, VAR_{flat} are set in dependence upon whether the corresponding user interaction 27 is moving or not. When user interaction types “hard” and “soft” are employed, the values of slope and variance thresholds m_{flat}, VAR_{flat} for non-moving user interactions 27 may be set in dependence on whether the user interaction 27 is of a “hard” or “soft” type. The specific threshold values are determined from calibration experiments with known applied force profiles, and should be selected so that the electrode channel updating step (step S80) does not detect a flat region and update the residual offset P_{cor} except at times when the known applied force profiles are not increasing or decreasing. In general, the slope and variance thresholds meat, VAR_{flat} for moving user interactions 27 are smaller than the slope and variance thresholds m_{flat}, VAR_{flat} for “soft” type user interactions 27, which are in turn smaller than the slope and variance thresholds m_{flat}, VAR_{flat} for “hard” type user interactions 27.

An electrode channel updating process is carried out, during which it is determined whether the pressure signal 18 from the electrode 5, 6 being processed is flat, or at least changing slowly enough, to update the residual offset correction value P_{cor} (step S80). The determination is made by comparing the slope, m, and variance, VAR, of the pressure samples {P(t,yₙ), P(t−1,yₙ), . . . , P(t−N_{buf6}+1,yₙ)} in the push elaboration buffer against the values of slope and variance thresholds m_{flat}, VAR_{flat} determined previously (step S79). Optionally, it may also be determined whether a “hard” type user interaction should transition into a “soft” type user interaction, and vice-versa.

The processed pressure sample P*(t,yₙ) is obtained by subtracting the present value of the residual offset P_{cor}(yₙ) from the pressure sample P(t,yₙ) according to P*(t,yₙ)=P(t,yₙ)−P_{cor}(yₙ) (step S81).

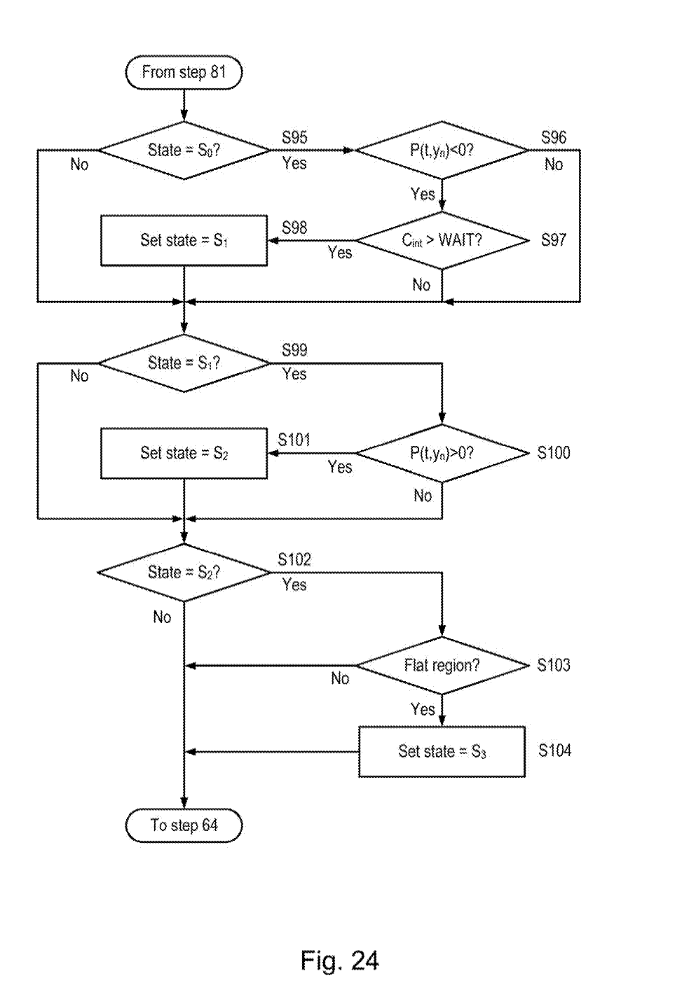

The state register value S₀, S₁, S₂, S₃ of the sensing electrode 5, 6 being processed is then updated by a state machine process (step S82), details of which are discussed hereinafter (FIG. 24).

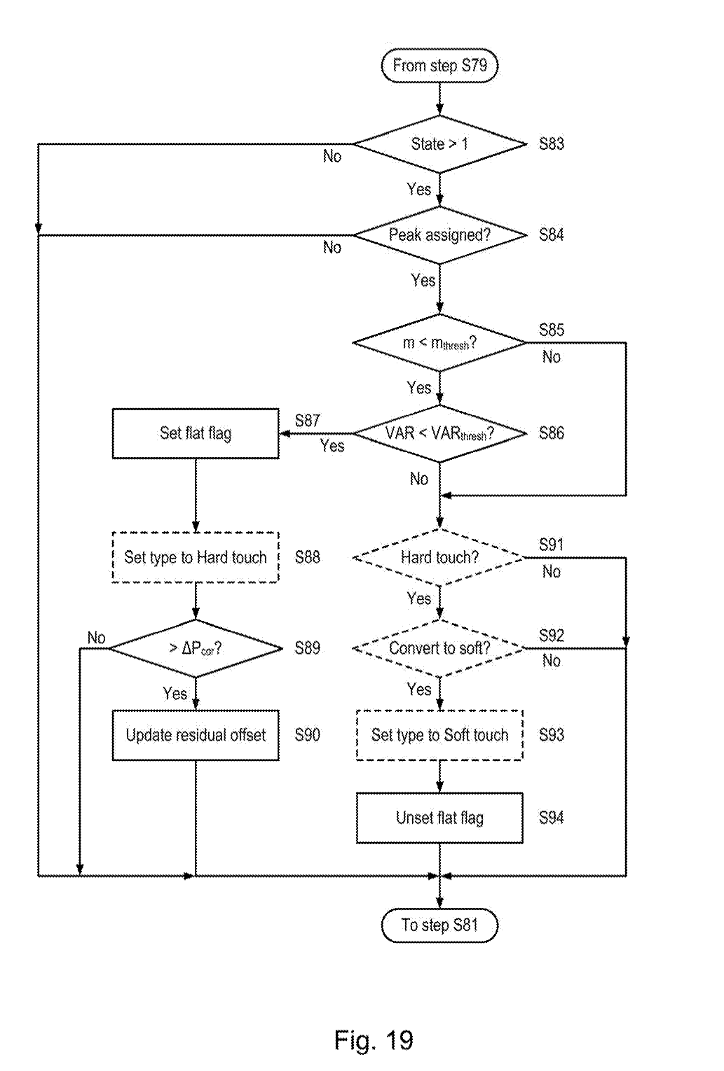

Electrode channel updating step: Referring also to FIG. 19, a process-flow diagram of an example of the electrode channel updating process (step S80) is shown.

The channel updating process is not carried out when the state register value corresponds to the first or second states S₀, S₁ (step S83), or when the initial peak P₁ has not yet been assigned (step S84)

If the sensing electrode being process has a state register value corresponding to the third or fourth states S2, S₃ (step S83) and the initial peak value P₁ has been assigned (step S84), the electrode channel updating process continues. Note that if the optional assignments of “hard” and “soft” types of user interaction are being employed, the assignment will have been made if the initial peak value P₁ has been assigned.

If the slope m determined from linear regression (step S70) is less than the slope threshold m_{flat} (step S85) and the variance VAR from linear regression (step S70) is less than the variance threshold VAR_{flat} (step S86), then a flat region flag is set to a value “true” for the sensing electrode 5, 6 being processed (step S87). In general, the slope and variance thresholds moat, VAR_{flat} for moving user interactions are smaller than the slope and variance thresholds m_{flat}, VAR_{flat} for “soft” type user interactions, which are in turn smaller than the slope and variance thresholds m_{flat}, VAR_{flat} for “hard” type user interactions. In this way, the conditions for updating the residual offset correction value P_{cor} may be relatively stricter for moving or “soft” type user interactions 27 than for “hard” type user interactions 27. This may avoid continuous updates to the residual offset correction value P_{cor} erroneously discounting a gradually increasing or decreasing applied force during movement or a “soft” type user interaction.

If the optional “soft” and “hard” type assignments are used, then a “soft” type user interaction 27 is re-assigned as a “hard” type user interaction in response to determining a flat region (step S88).

The residual offset correction P_{cor} cannot be continuously updated during flat periods of the pressure signal 18 for the sensing electrode 5, 6 being processed, since this would lead to ignoring small changes in applied force. Instead, the difference of the current residual offset P_{cor} and the mean value obtained from the linear regression (step S70) is obtained as P_{cor}−MEAN({P(t,yₙ), P(t−1,yₙ), . . . , P(t−N_{buf6}+1,yₙ)}), and if the magnitude of this difference exceeds a threshold value ΔP_{cor} (step S89), the residual offset correction value P_{cor} is updated as P_{cor}=MEAN({P(t,yₙ), P(t−1,yₙ), . . . , P(t−N_{buf6}1,yₙ)}) (step S90).

However, if the slope m determined from linear regression (step S70) is greater than or equal to the slope threshold m_{flat} (step S85) or the variance VAR from linear regression (step S70) is greater than or equal to the variance threshold VAR_{flat} (step S86), then the flat region flag is set to a value “false” for the sensing electrode 5, 6 being processed (step S94).

Optionally, if a user interaction 27 is a “hard” type (step S91), the pressure signal processing module 15 determines whether the user interaction 27 should be re-assigned as a “soft” type user interaction 27 (step S92). The user interaction 27 should be re-assigned as a “soft” type user interaction if the pressure sample P(t, yₙ) exceeds a pre-specified fraction f_{soft} of the stored magnitude of the initial loading peak P₁ and when the magnitude of the slope m determined from linear regression (step S70) exceeds a maximum value m_{soft}. When these conditions are met, the user interaction can no longer be assumed to be a “hard” type, and is set to a “soft” type instead (step S93). The fraction f_{soft} and the maximum value m_{soft} may be determined for a given touch panel 1 and system 13 from suitable calibration experiments using predetermined applied force profiles, and may vary within the ranges 0.1≤f_{soft}≤0.9 and 0.5<m_{soft}<5.

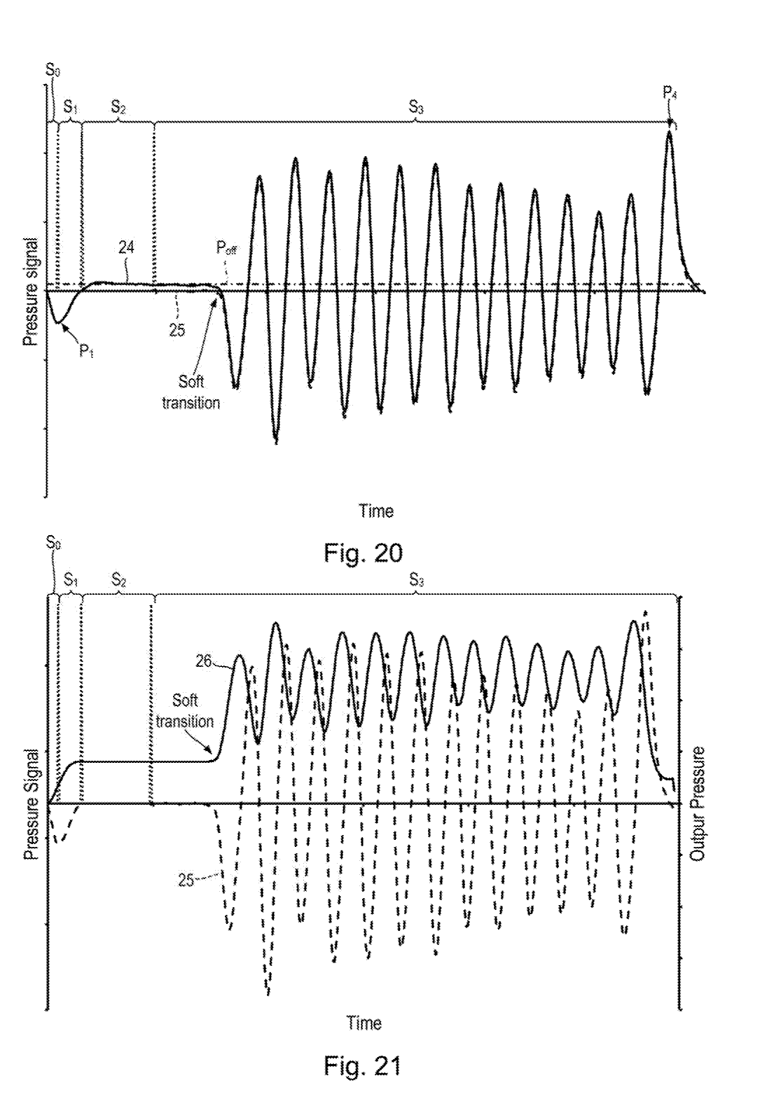

Referring also to FIGS. 20 and 21, a measured pressure signal 24, processed pressure signal 25 and output force 26 are shown for a “hard” type user interaction 27 which transitions to a “soft” type user interaction 27. The point of the transition is indicated on the figures by the arrow labelled “Soft transition”. Note that the terms “hard” and “soft” do not necessarily correlate with the actual magnitude of the pressure signal 24 and force output 26. Rather, the terms “hard” and “soft” are more closely related to the initial rate of increase of the pressure signal 24. The inventors have found that inaccurate handling of the initial increase of the pressure signal 24 can have significant effects on the subsequent measurement of output forces 26 for the remainder of a user interaction 27, and that the distinction between “hard” and “soft” type user interactions 27 may, in some examples, improve accuracy of the measured output forces.

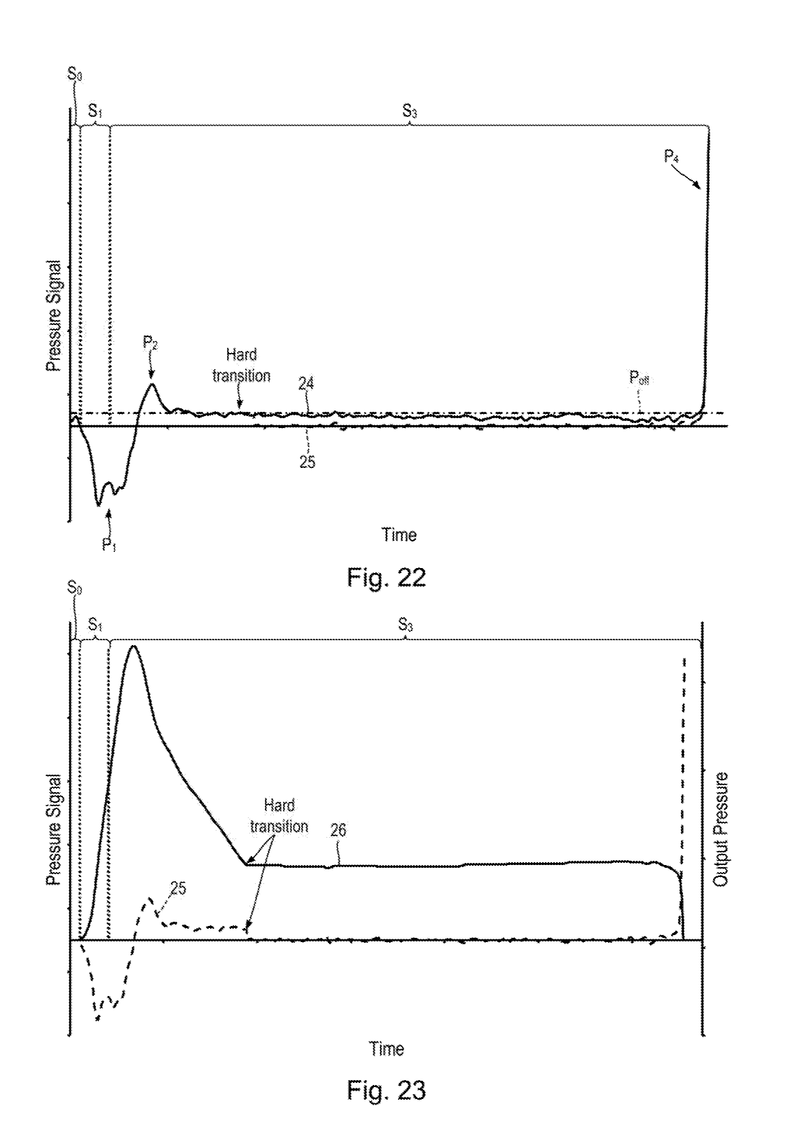

Referring also to FIGS. 22 and 23, a measured pressure signal 24, processed pressure signal 25 and output force 26 are shown for a “soft” type user interaction 27 which transitions to a “hard” type user interaction 27 because the applied force becomes constant and a flat region is detected. The point of the transition is indicated on the figures by the arrow labelled “Hard transition”.

First state machine: Referring also to FIG. 24, a process-flow diagram of a first example of the state machine process (step S82) is shown. The first example of the state machine process (step S82) does not include the optional assignment of “hard” and “soft” types of user interaction 27.

All new user interactions 27 are initialised in the first, initial state S₀, and the state machine (step S82) processes the state register value S₀, S₁, S₂, S₃ of the sensing electrode 5, 6 being processed with each received pressure sample P(t, yₙ), updating the state register value when particular conditions are met.

If the sensing electrode 5, 6 being processed has state register corresponding to the initial state S₀ (step S95), the pressure sample P(t,yₙ) is less than zero (step S96), and the time elapsed since the beginning of the user interaction, tracked by the counter Cᵢₙₜ (step S57) exceeds a predetermined minimum value WAIT (step S97), the state register of the sensing electrode 5, 6 being processed is updated to the second, primary loading state S₁ (step S98).

The sign checked in step S96 depends on the configuration of the touch panel 1 and system 13. If an increasing applied force registers as a decreasing pressure signal 18, as shown in the examples of the present specification, the test is P(t,yₙ)<0. However, if an increasing applied force registers as an increasing pressure signal 18, then the test would instead by P(t,yₙ)>0.

If the sensing electrode 5, 6 being processed has state register corresponding to the second, primary loading state S₁ (step S99), and the pressure sample P(t,yₙ) is greater than zero (step S100), the state register of the sensing electrode 5, 6 being processed is updated to the third, settling state S₂ (step S101).

The sign checked in step S100 depends on the configuration of the touch panel 1 and system 13. If an increasing applied force registers as a decreasing pressure signal 18, as shown in the examples of the present specification, the test is P(t,yₙ)>0. However, if an increasing applied force registers as an increasing pressure signal 18, then the test would instead by P(t,yₙ)<0.

If the sensing electrode 5, 6 being processed has state register corresponding to the third, settling state S₂ (step S102), and the flat region flag has the value “true” (step S103), then the state register of the sensing electrode 5, 6 being processed is updated to the fourth, stable state S₃ (step S104). Note that the flat region flag cannot be set to the value “true” until after the initial loading peak P₁ has been determined.

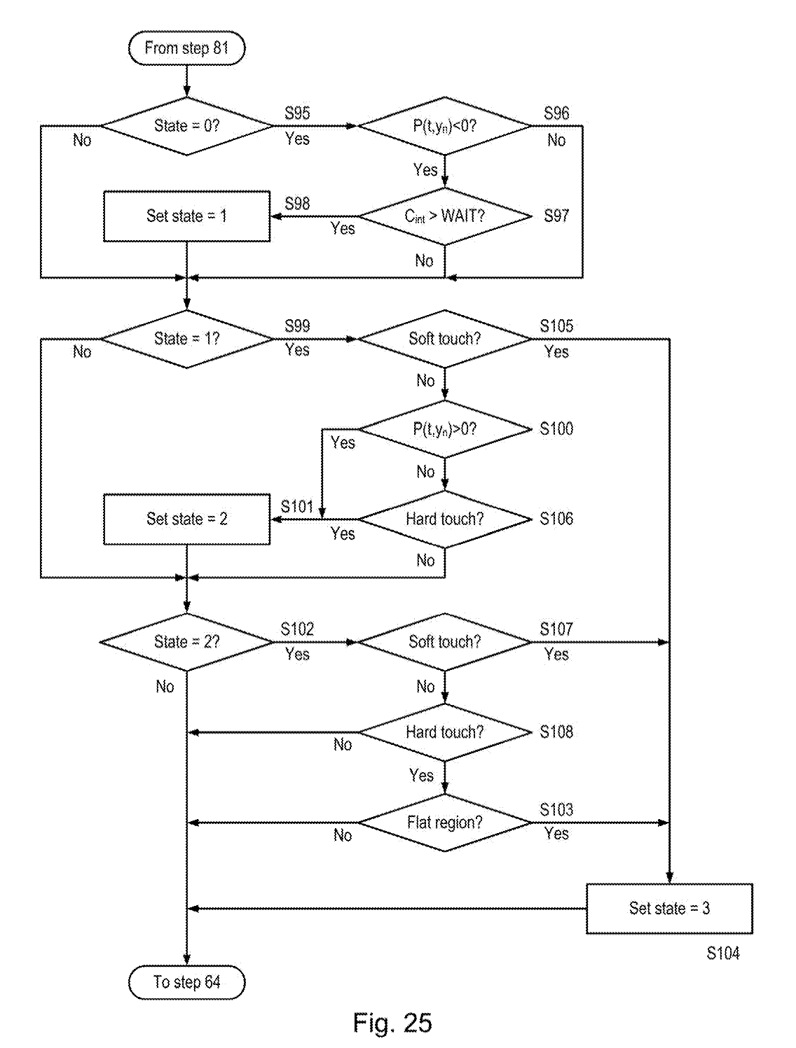

Second state machine: Referring also to FIG. 25, a process-flow diagram of a second example of the state machine process (step S82) is shown. The second example of the state machine process (step S82) includes the optional assignment of “hard” and “soft” type user interactions 27.

The transition between state register values S₀ and S₁ is the same as for the first state machine (steps S95 to S98).

If the sensing electrode 5, 6 being processed has state register corresponding to the second, primary loading state S₁ (step S99), and the type of user interaction 27 is “soft” (step S105), the state register of the sensing electrode 5, 6 being processed is updated to the fourth, stable state S₃ (step S104). In this way, a “soft” type user interaction 27 may skip the third, settling state S₂.

If the sensing electrode 5, 6 being processed has state register corresponding to the second, primary loading state S₁ (step S99), the type of user interaction 27 is not “soft” (step S105), and either the pressure sample P(t,yₙ) is greater than zero (step S100) or the type of user interaction 27 is “hard” (step S106), the state register of the sensing electrode 5, 6 being processed is updated to the third, settling state S₂ (step S101).

If the sensing electrode 5, 6 being processed has state register corresponding to the third, settling state S₂ (step S102), and the type of user interaction 27 is “soft” (step S107), the state register of the sensing electrode 5, 6 being processed is updated to the fourth, stable state S₃ (step S104).

If the sensing electrode 5, 6 being processed has state register corresponding to the third, settling state S₂ (step S102), the type of user interaction 27 is not “soft” (step S107), the type of user interaction 27 is “hard” (step S108), and the flat region flag has the value “true” (step S103), the state register of the sensing electrode 5, 6 being processed is updated to the fourth, stable state S₃ (step S104).

Note that the flat region flag and the assignment of “hard” or “soft” type cannot be made until after the initial loading peak P₁ has been determined.

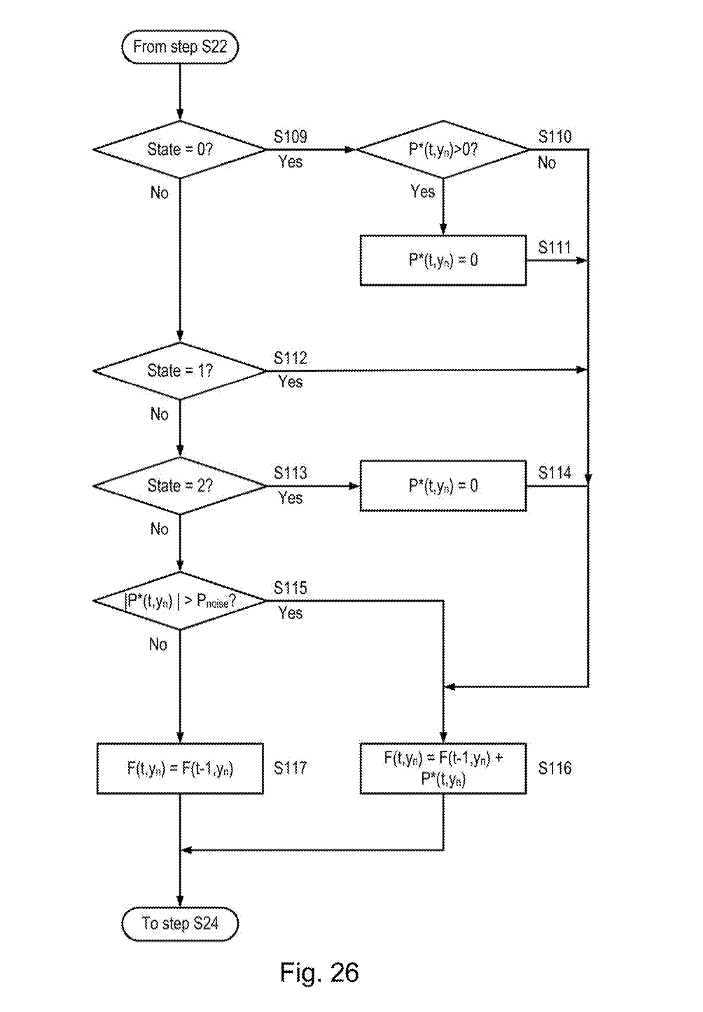

Updating output force values: Referring also to FIG. 26, a process flow diagram of an example of updating the output force 26 values {F(t, y₁), F(t, y₂), . . . , F(t, y_{N})}, {F(t, x₁), F(t, x₂), . . . , F(t, x_{M})} (step S23) is shown.

The step of updating the output force values (step S23) is carried out for each sensing electrode 5, 6, and the ordering of the sensing electrodes 5, 6 is not important for this process. For example, the ordering used for the push elaboration process (step S22) may be used. The output force updating process shall be explained with reference to the n^{th} of N first sensing electrodes 5, however, the output force updating process is the same for each other sensing electrode 5, 6.

If the n^{th} of N first sensing electrodes 5 has state register corresponding to the first, initial state S₀ (step S109) and the processed pressure sample P*(t,yₙ) is greater than zero (step S110), then the processed pressure sample P*(t,yₙ) is set equal to zero (step S111) and the output force is updated as F(t,yₙ)=F(t−1,yₙ)+P*(t,yₙ) (step S116).

The sign checked in step S110 depends on the configuration of the touch panel 1 and system 13. If an increasing applied force registers as a decreasing pressure signal 24, as shown in the examples of the present specification, the test is P*(t,yₙ)>0. However, if an increasing applied force registers as an increasing pressure signal 24, then the test would instead by P(t,yₙ)<0.

If the n^{th} of N first sensing electrodes 5 has state register corresponding to the first, initial state S₀ (step S109) and the processed pressure sample P*(t,yₙ) is less than or equal to zero (step S110), then the output force is updated as F(t,yₙ)=F(t−1,yₙ)+P*(t,yₙ) (step S116).

If the n^{th} of N first sensing electrodes 5 has state register corresponding to the second, primary loading state S₁ (step S112), then the output force is updated as F(t,yₙ)=F(t−1,yₙ)+P*(t,yₙ) (step S116).

If the n^{th} of N first sensing electrodes 5 has state register corresponding to the third, settling state S₂ (step S113), then the pressure sample P*(t,yₙ) is unconditionally set equal to zero (step S114) and the output force is updated as F(t,yₙ)=F(t−1,yₙ)+P*(t,yₙ) (step S116).

If the n^{th} of N first sensing electrodes 5 has state register corresponding to the fourth, stable state S₃, i.e. not in the initial state S₀ (step S109), the primary loading state S₁ (step S112) or the settling state S₂ (step S113), then if the magnitude of the processed pressure sample P*(t,yₙ) exceeds a pre-determined noise threshold Pₙₒᵢₛₑ (step S115), then the output force is updated as F(t,yₙ)=F(t−1,yₙ)+P*(t,yₙ) (step S116).

If the n^{th} of N first sensing electrodes 5 has stage register corresponding to the fourth, stable state S₃, i.e. not in the initial state S₀ (step S109), the primary loading state S₁ (step S112) or the settling state S₂ (step S113), then if the magnitude of the processed pressure sample P*(t,yₙ) does not exceed the pre-determined noise threshold Pₙₒᵢₛₑ (step S115), then the output force is updated as F(t,yₙ)=F(t−1,yₙ) (step S117).

In other examples, the updating of the output forces F(t) may use higher order numerical integration, such as, for example, the trapezium rule, i.e. F(t,yₙ)=F(t−1,yₙ)+0.5*(P*(t,yₙ)+P*(t−1,yₙ))

It will be appreciated that many modifications may be made to the embodiments hereinbefore described. Such modifications may involve equivalent and other features which are already known in the design, manufacture and use of capacitive touch panels and which may be used instead of or in addition to features already described herein. Features of one embodiment may be replaced or supplemented by features of another embodiment. For example, features of one display stack-up or embedded display stack-up may be replaced or supplemented by features of other display stack-ups and/or other embedded display stack-ups.

The methods of the present specification may be of use in any touch panel system which is capable of using capacitive touch methods to measure the capacitance information 20 comprising the number and locations of one or more user interactions, and which is also capable, either concurrently or consecutively, of measuring pressure signals 18 generated by straining a layer of piezoelectric material 9. In the touch panel 1 and system 13, the pressure and capacitance signals 18,19 are generated by a single set of electrodes. However, the methods of the present specification are equally applicable to entirely separate piezoelectric and capacitive touch sensors which are, interleaved with one another or stacked on top of one another.

Although the measurement front end 14, the pressure signal processing module 15 and the capacitance signal processing module 16 have been described as separate components, this need not be the ease. In some example, the pressure signal processing module 15 and the capacitance signal processing module 16 may be integrated and provided by a single controller or application specific integrated circuit (ASIC). In further examples, the functionalities of the measurement front end 14, the pressure signal processing module 15 and the capacitance signal processing module 16 may all be provided by a single controller or ASIC.

Whilst a detailed implementation of the methods of the present specification has been described in relation to FIGS. 8 to 26, it should be appreciated that any given step or process of the exemplary implementation may be isolated and separately implemented in the methods of the present specification, subject only to also implementing steps or processes which provide necessary input for the given step or process.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

What is claimed is:

1. A method comprising:
receiving, from a touch panel, pressure signals from a plurality of piezoelectric sensors and capacitance signals from a plurality of capacitive touch sensors;
determining, based on the capacitance signals, a user interaction period during which a user interaction with the touch panel occurs;
generating processed pressure signals based on the received pressure signals;
measuring a force applied to each of the plurality of piezoelectric sensors by the user interaction during the user interaction period by conditionally integrating the corresponding processed pressure signals according to a state register corresponding to the user interaction;
wherein the state register takes one of two or more values, wherein each user interaction is initialised in a first state value, and wherein the user interaction transitions between state register values in dependence upon the current state register value and one or more pressure signal properties.

2. A method according to claim 1, wherein generating the processed pressure signals comprises, for each piezoelectric sensor, subtracting a DC offset value from the received pressure signal;
wherein each DC offset value is initialised after a warm-up period has elapsed following switching on the touch panel, and the initial DC offset value is based on the received pressure signals in the absence of a user interaction.

3. A method according to claim 2, further comprising, for each piezoelectric sensor, in response to determining that there is no user interaction:
maintaining a regression buffer of received pressure signal values;
determining a gradient and variance of the values stored in the regression buffer; and
in response to the gradient and variance being less than predetermined threshold values, updating the DC offset value based on the values stored in the regression buffer.

4. A method according to claim 1, further comprising, for each piezoelectric sensor:
in response to detecting the start of a user interaction, setting a residual DC offset value to zero;
during the user interaction period:
maintaining a sample buffer of processed pressure signal values;
determining a gradient and variance of the values stored in the sample buffer;
determining a difference between the residual DC offset value and the average value of the values stored in the sample buffer; and
in response to the gradient and variance being less than corresponding flat-period threshold values and the difference being greater than an offset-shift threshold, updating the residual DC offset value to the average value of the values stored in the sample buffer;
subtracting the residual DC offset value from the processed pressure signal before integration.

5. A method according to claim 4, further comprising setting a movement flag to a value of true in response to determining, based on the capacitance signals, that the location of a user interaction is moving;
in response to the movement flag does not have a value of true, setting the flat-period threshold values to first predetermined flat-period threshold values;
in response to the movement flag has a value of true, setting the flat-period threshold values to second predetermined flat-period threshold values.

6. A method according to claim 1, further comprising, for each piezoelectric sensor, locating and determining an initial peak value of the processed pressure signal during the user interaction period.

7. A method according to claim 6, further comprising, in response to locating an initial peak value:
setting a user interaction type register to correspond to a soft touch value in response to the elapsed time since the start of the user interaction period exceeds a predetermined threshold value;
setting the user interaction type register to correspond to a hard touch value in response to the elapsed time since the start of the user interaction period does not exceed the predetermined threshold value.

8. A method according to claim 4, further comprising:
for each piezoelectric sensor, locating and determining an initial peak value of the processed pressure signal during the user interaction period;
in response to locating an initial peak value:
setting a user interaction type register to correspond to a soft touch value in response to the elapsed time since the start of the user interaction period exceeds a predetermined threshold value;
setting the user interaction type register to correspond to a hard touch value in response to the elapsed time since the start of the user interaction period does not exceed the predetermined threshold value;
further comprising setting the user interaction type register to the hard touch value in response to:
the residual DC offset value is updated; and
the user interaction type register corresponds to the soft touch value.

9. A method according to claim 8, further comprising setting the user interaction type register to the soft touch value in response to:
the processed pressure signal exceeds a predetermined fraction of the initial peak value;
the gradient of the values stored in the sample buffer exceed a soft-transition threshold; and
the user interaction type register corresponds to the hard touch value.

10. A method according to claim 1, further comprising setting the state register to a second state value in response to:
the state register corresponds to the first state value;
a time elapsed since the start of the user interaction exceeds a minimum duration; and
the processed pressure signal has a sign corresponding to an increasing force;
wherein if the state register corresponds to the second state value, all processed pressure signal values are integrated.

11. A method according to claim 10, further comprising setting the state register to a third state value in response to:
the state register corresponds to the second state value; and
the processed pressure signal has a sign corresponding to a decreasing force;
wherein if the state register corresponds to the third state value, no processed pressure signal values are integrated.

12. A method according to claim 11, further comprising setting the state register to a third state value in response to:
the state register corresponds to the second state value; and
a user interaction type register corresponds to a soft touch value.

13. A method according to claim ii, further comprising:
determining a signal gradient of the processed pressure signal during the user interaction; and
setting the state register to a fourth state value in response to:
the state register corresponds to the third state value; and
the processed pressure signal has a signal gradient below a signal gradient threshold;
wherein if the state register corresponds to the fourth state value, processed pressure signal values which exceed a noise threshold are integrated and processed pressure signal values which do not exceed the noise threshold are not integrated.

14. A method according to claim 1, wherein if the state register corresponds to the first state value, processed pressure signal values having a sign corresponding to an increasing force are integrated and processed pressure signal values corresponding to a decreasing force are not integrated.

15. A method according to claim 1, wherein the state register is set separately for each of the plurality of piezoelectric sensors.

16. A method according to claim 1, comprising:
determining, based on the capacitance signals, two or more user interactions with the touch panel;
determining a location of each user interaction based on the capacitance signals;
assigning a piezoelectric sensor which is closest to the location of each user interaction as a decision making sensor;
assigning each other piezoelectric sensor to correspond to the closest decision making sensor;
in response to a piezoelectric sensor is a decision making sensor, updating a state register corresponding to the piezoelectric sensor independently;
in response to a piezoelectric sensor is not a decision making sensor, updating a state register corresponding to the piezoelectric sensor to be equal to the state register of the corresponding decision making sensor.

17. A method according to claim 16, further comprising processing signals from decision making sensors before processing signals from the other piezoelectric sensors.

18. A computer program stored on a non-transitory computer readable medium and comprising instructions for causing a data processing apparatus to execute a method according to claim 1.

19. A controller configured for connection to a touch panel comprising a plurality of piezoelectric sensors and a plurality of capacitive touch sensors, the controller configured to:
receive pressure signals from the plurality of piezoelectric sensors and capacitance signals from the plurality of capacitive touch sensors;
determine, based on the capacitance signals, a user interaction period during which a user interaction with the touch panel occurs;
generate processed pressure signals based on the received pressure signals;
measure a force applied to each of the plurality of piezoelectric sensors by the user interaction during the user interaction period by conditionally integrating the corresponding processed pressure signals according to a state register corresponding to the user interaction;
wherein the state register takes one of two or more values, wherein each user interaction is initialised in a first state value, and wherein the, user interaction transitions between state register values in dependence upon the current state register value and one or more pressure signal properties.

20. Apparatus comprising:
the controller according to claim 19; and
a touch panel comprising a plurality of piezoelectric sensors and a plurality of capacitive touch sensors.
